(19) United States
(12) Patent Application Publication
(10) Pub. No.: US 2022/0353231 A1
(43) Pub. Date: Nov. 3, 2022

(54) MESSAGE PROCESSING METHOD, APPARATUS, AND DEVICE, AND STORAGE MEDIUM

(71) Applicant: Tencent Technology (Shenzhen) Company Limited, Shenzhen (CN)

(72) Inventors: Dan HE, Shenzhen (CN); Yining CAI, Shenzhen (CN); Liqiang LIU, Shenzhen (CN); Ailu DENG, Shenzhen (CN); Zhuo XU, Shenzhen (CN)

(21) Appl. No.: 17/867,596

(22) Filed: Jul. 18, 2022

Related U.S. Application Data
(63) Continuation of application No. PCT/CN2021/092628, filed on May 10, 2021.

(30) Foreign Application Priority Data
Jun. 5, 2020 (CN) 2020105603.0

(51) Int. Cl. H04L 51/52; G06Q 50/00

(52) U.S. Cl. CPC H04L 51/52; G06Q 50/01

(57) ABSTRACT

Embodiments of the present disclosure disclose a message processing method performed by a mobile device. The method may include: displaying a target social networking state mark of a target user on a social networking page of a social networking application, the target social networking state mark being determined according to a preset target option related to the target user, and the target social networking state mark being used for representing the current social networking state of the target user; and displaying a target message related to a trigger event matching the target option in the social networking application when the trigger event is detected based on an update to at least one parameter of the mobile device.

### CROSS-REFERENCE TO RELATED APPLICATIONS

This application is a continuation application of PCT Patent Application No. PCT/CN2021/092628, entitled “MESSAGE PROCESSING METHOD, APPARATUS AND DEVICE, AND STORAGE MEDIUM” filed on May 10, 2021, which claims priority to Chinese Patent Application No. 202010515603.0, filed with the State Intellectual Property Office of the People's Republic of China on Jun. 5, 2020, and entitled “MESSAGE PROCESSING METHOD, APPARATUS, AND DEVICE, AND STORAGE MEDIUM”, all of which are incorporated herein by reference in their entirety.

### FIELD OF THE TECHNOLOGY

This application relates to the technical field of computers, and in particular, to a message processing method, apparatus, and device, and a storage medium.

### BACKGROUND OF THE DISCLOSURE

In the contemporary era of continuous technological innovation, in order to provide users with better convenience to gain more attention, an application developer keeps adding more interesting functions to attract more users when developing an application. For example, the developer adds an online state function to a social networking application. The so-called online state is a text description of a current status of the user, for example, the online state is Online, Offline, Traveling, Working, and the like. After the user sets the online state in the social networking application, the online state may be displayed at locations such as in a friend list, a chat window, and the like for the user or friends to view.

The existing online state function is relatively simple, which is mainly used for showing the current status of the user, so that the friends can know, from the online state set by the user, whether the user is currently suitable for chatting. Therefore, how to enrich the online state function in the social networking application to improve the utilization and attention of the social networking application has become a hot research issue nowadays.

### SUMMARY

According to various embodiments provided in this application, a message processing method, apparatus, and device, and a storage medium are provided.

According to one aspect, an embodiment of the present disclosure provides a message processing method, performed by a mobile device and including:

displaying a target social networking state mark of a target user on a social networking page of a social networking application, the target social networking state mark being determined according to a preset target option related to the target user, and the target social networking state mark being used for representing the current social networking state of the target user; and

displaying a target message related to a trigger event matching the target option in the social networking application when the trigger event is detected based on an update to at least one parameter of the mobile device.

According to one aspect, an embodiment of the present disclosure provides a mobile device, including:

a processor, adapted to execute one or more instructions; and

a non-transitory computer storage medium, storing one or more instructions, the one or more instructions being adapted to be loaded and executed by the processor to implement the following operations:

displaying a target social networking state mark of a target user on a social networking page of a social networking application, the target social networking state mark being determined according to a preset target option related to the target user, and the target social networking state mark being used for representing the current social networking state of the target user; and

displaying a target message related to a trigger event matching the target option in the social networking application when the trigger event is detected based on an update to at least one parameter of the mobile device.

According to one aspect, an embodiment of the present disclosure provides a non-transitory computer storage medium. The computer storage medium stores computer program instructions, the computer program instructions, when executed by a processor of a mobile device, causing the processor to perform the following operations:

displaying a target social networking state mark of a target user on a social networking page of a social networking application, the target social networking state mark being determined according to a preset target option related to the target user, and the target social networking state mark being used for representing the current social networking state of the target user; and

displaying a target message related to a trigger event matching the target option in the social networking application when the trigger event is detected based on an update to at least one parameter of the mobile device.

Details of one or more embodiments of this application are provided in the subsequent accompanying drawings and descriptions. Other features, objectives, and advantages of this application become apparent from the specification, the accompanying drawings, and the claims.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a schematic structural diagram of a message processing system according to an embodiment of the present disclosure.

FIG. 2 is a schematic flowchart of a message processing method according to an embodiment of the present disclosure.

FIG. 3 is a schematic diagram of selecting a target social networking state according to an embodiment of the present disclosure.

FIG. 4 is a schematic flowchart of another message processing method according to an embodiment of the present disclosure.

FIG. 5A is a schematic diagram of setting a candidate substrate according to an embodiment of the present disclosure.

FIG. 5B is a schematic diagram of a configuration switching mode according to an embodiment of the present disclosure.

FIG. 5C is a schematic diagram of displaying a switching prompt message according to an embodiment of the present disclosure.

FIG. 5D is a schematic diagram of displaying another switching prompt message according to an embodiment of the present disclosure.

FIG. 6 is an interaction diagram of a message processing method according to an embodiment of the present disclosure.

FIG. 7 is a schematic flowchart of still another message processing method according to an embodiment of the present disclosure.

FIG. 8A is a schematic diagram of displaying another switching prompt message according to an embodiment of the present disclosure.

FIG. 8B is a schematic diagram of binding a location to an activity state according to an embodiment of the present disclosure.

FIG. 8C is a schematic diagram of a conversation interface according to an embodiment of the present disclosure.

FIG. 8D is an interaction diagram of another message processing method according to an embodiment of the present disclosure.

FIG. 9 is a schematic flowchart of still another message processing method according to an embodiment of the present disclosure.

FIG. 10A is a schematic diagram of configuring a second type of social networking state according to an embodiment of the present disclosure.

FIG. 10B is a schematic diagram of displaying a target message according to an embodiment of the present disclosure.

FIG. 10C is an interaction diagram of another message processing method according to an embodiment of the present disclosure.

FIG. 11 is a schematic flowchart of still another message processing method according to an embodiment of the present disclosure.

FIG. 12A is a schematic diagram of setting a Do Not Disturb mode according to an embodiment of the present disclosure.

FIG. 12B is a schematic diagram of a prompt box displaying the Do Not Disturb mode enabled according to an embodiment of the present disclosure.

FIG. 12C is a schematic diagram of displaying a notification message according to an embodiment of the present disclosure.

FIG. 12D is a schematic diagram of displaying a prompt message according to an embodiment of the present disclosure.

FIG. 12E is a schematic diagram of viewing a conversation message in a message box according to an embodiment of the present disclosure.

FIG. 12F is a schematic diagram of a conversation between a target user and a contact user according to an embodiment of the present disclosure.

FIG. 13 is a schematic structural diagram of a message processing apparatus according to an embodiment of the present invention.

FIG. 14 is a schematic structural diagram of a message processing device according to an embodiment of the present disclosure.

### DESCRIPTION OF EMBODIMENTS

The following clearly and completely describes the technical solutions in the embodiments of the present invention with reference to the accompanying drawings in the embodiments of the present invention.

Embodiments of the present disclosure provide a message processing solution. In a case that a user selects a target option related to a social networking state, a target social networking state mark is displayed on a social networking page of a social networking application according to the target option. In addition, when a trigger event matching the target option exists, a target message related to the trigger event is displayed in the social networking application, thereby associating the social networking state with the target message, and enriching the social networking state function.

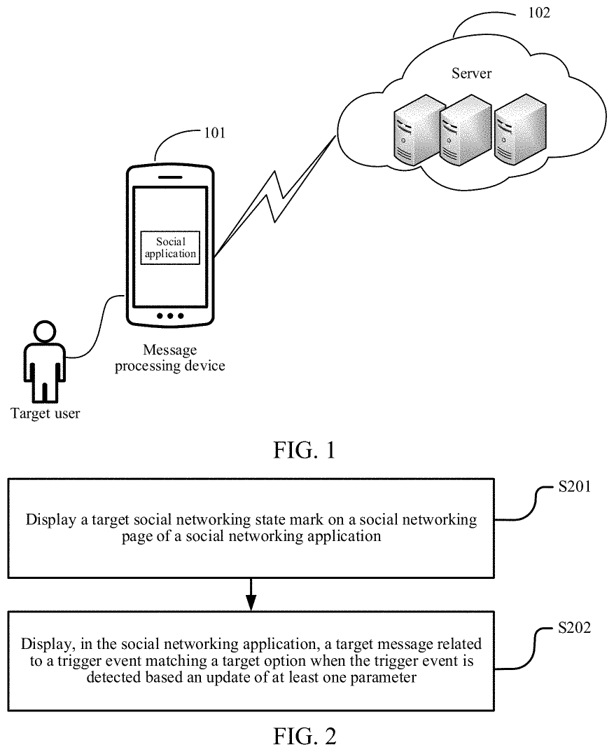

Based on the above message processing solution, an embodiment of the present disclosure provides a message processing system. FIG. 1 is a schematic structural diagram of a message processing system according to an embodiment of the present disclosure. The message processing system shown in FIG. 1 may include a message processing device 101 and a server 102. A social networking application can be run in the message processing device 101. The social networking application may be, for example, an instant messaging application such as QQ, Enterprise WeChat, WeChat, and the like. The social networking application may further include a non-instant messaging application, such as a text messaging application, WeiBo, and the like. The message processing device 101 may be a terminal device such as a computer, a notebook computer, a smart wearable device, and the like.

The server 102 is configured to provide support for running of the social networking application in the message processing device 101. The server 102 may be an independent physical server, or may be a server cluster composed of a plurality of physical servers or a distributed system, and may further be a cloud server configured to provide basic cloud computing services such as a cloud service, a cloud database, cloud computing, a cloud function, cloud storage, a network service, cloud communication, a middleware service, a domain name service, a security service, CDN, a big data and artificial intelligence platform, and the like.

In an embodiment, a user account of a target user is logged in to the social networking application. The social networking application includes a social networking state function (or referred to as an online state function). The so-called social networking state is a current status of the target user who uses the social networking application, such as online, offline, busy, invisible, or the like. The target user may use the social networking state function by using a social network state list page of the social networking application. The social network state list page may include a plurality of to-be-selected types related to the social networking state, such as social networking state options and a trigger option for triggering the message processing device to identify the social networking state in a target identification mode. In a case that the trigger option is triggered, the message processing device automatically identifies the current social networking state of the target user according to current location information and/or movement information of the target user. Some feasible implementations included in the part are to be described in detail in the following embodiments.

Each social networking state option included in the social network state list page corresponds to a social networking state. The social networking states may be of different types. Specifically, the social networking state indicated by each social networking state option in the social networking state list may be divided into the following types according to the different type of each social networking state: a first type of social networking state, a second type of social networking state, a third type of social networking state, and other types of social networking states.

The first type of social networking state may be referred to as “my location”, which means that the social networking state of the target user at a moment is determined in real time according to location information of the target user at the moment. For example, the current location information of the target user is “XXX office building in Chongqing”, and then the current social networking state of the target user is “XXX office building in Chongqing”. For another example, the current location information of the target user is: “Shenzhen XX Fitness Center”, and then the current social networking state of the target user is “Shenzhen XX Fitness Center”.

The second type of social networking state may be any social networking state related to work or study, such as “Working”, “Learning”, “In a Meeting”, “In Class”, or the like.

The third type of social networking state may be a social networking state that is a current social networking state of the target user required to be determined in real time according to any one or more of weather information, date information, and a message processing device status. For example, the third type of social networking state may include “Horoscope”, “My Weather”, “My Power”, and the like.

It is to be understood that the first type of social networking state and the third type of social networking state dynamically change. The other types of social networking states include static social networking states and do not include the third type of social networking state, such as “On Vacation”, “On leave”, “Dining”, “Do Not Disturb”, and the like.

In an embodiment, the target user may select any target option related to the social networking state in the social network state list page by using the message processing device 101. That is, the target option is the option selected by a user from options related to the social networking states in the social network state list page. For example, the social network state list page may include options of the first type of social networking state, options of the second type of social networking state, and options of the third type of social networking state. Specifically, the social network state list page may include options of “My Location”, “Working”, “Learning”, “In a Meeting”, “In Class”, “Horoscope”, “My Weather”, “My Power”, and the like. In a case that the user selects the “My Location” option, the “My Location” option is the target option. The message processing device 101 determines the current social networking state of the target user according to the target option selected by the target user, and displays the target social networking state mark on the social networking page of the social networking application. The target social networking state mark is used for marking the current social networking state of the target user. Then the message processing device 101 may notify, to the server 102, the target option selected by the target user and data related to the target option, and the server 102 stores the target option selected by the target user and the related data. In this way, even if the target user switches a new message processing device to log in to the social networking application, the previous setting related to the social networking state of the target user can still be viewed on a new message processing device. In addition, a contact user of the target user may acquire a real-time social networking state of the target user from the server 102 by using the corresponding message processing device, and display the real-time social networking state in the social networking application to which the contact user logs in. In this way, the contact user can learn the social networking state of the target user, and can further create more social interaction according to the social networking state of the target user. The target user and the contact user are users who use the social networking application to socialize. The target user is a user who uses the social networking state function by using the social network state list page of the social networking application, and the contact user is a user who can acquire the real-time social networking state of the target user by using the social networking application.

For example, when the social networking state of the target user is My Power, and the contact user of the target user is chatting with the target user, the contact user finds, by using the social networking state of the target user, that the mobile phone power of the target user is close to 1%, and the contact user may send a charging reminder to a target friend to remind the friend to charge the phone in time. In an embodiment, when the message processing device of the contact user learns, according to the social networking state of the target user, that the power of the message processing device used by the target user is lower than a threshold, a charging reminder option for sending a charging reminder with one key may be displayed in a chat window. The contact user may timely remind, by triggering the charging reminder option, the target user to charge the message processing device.

After the target option related to the social networking state is set by using the message processing system shown in FIG. 1, the message processing device may further monitor, in real time, the social networking state of the target user determined according to the target option, and may push, to the contact user of the target user as appropriate, a message reminding the target user to execute some events. For example, when the social networking state of the target user is My Weather, and the message processing device detects that the current social networking state of the target user is “There will be heavy rain in Nanshan, Shenzhen”. At this point, in order to promote the friend relationship between the target user and a designated contact user that is a friend particularly concerned about, a message can be pushed to the designated contact of the target user, so that the designated contact reminds the target user that there will be heavy rain and to remember to bring an umbrella when going out.

In a word, in the embodiment of the present disclosure, the social networking state function is enriched, and the user can generate more social interaction by using the social networking state of the friend, thereby enhancing the friendship with the friend, and improving the utilization and attention of the social networking application.

Based on the foregoing message processing system, an embodiment of the present disclosure provides a message processing method. FIG. 2 is a schematic flowchart of a message processing method according to an embodiment of the present disclosure. The message processing method shown in FIG. 2 may be performed by a message processing device, and may specifically be performed by a processor of the message processing device. The message processing method shown in FIG. 2 may include the following steps.

Step S201: Display a target social networking state mark of a target user on a social networking page of a social networking application.

It may be learned from the foregoing that a user account of the target user may be logged in to the social networking application. The social networking page may include a status display interface and a conversation interface. The status display interface is an interface on which the target social networking state mark of the target user can be displayed, and the conversation interface is a conversation interface on which the target user has a conversation with the contact user. For example, when the social networking application is QQ, the status display interface may be a “message page” and a “contact page”. In the message page, the target social networking state mark may be displayed around the user account of the target user in an upper left corner or displayed in any other location on the message page. On the contact page, the target social networking state mark may be displayed at the location of the user account of the target user in My Friend List.

In an embodiment, the target social networking state mark is used for representing the current social networking state of the target user, and the target social networking state mark is determined according to a selected target option related to the social networking state. Specifically, the target option is selected, and then the target social networking state mark is determined according to the target option, and the target social networking state mark is displayed on the social networking page of the social networking application.

In an embodiment, the target option is selected from the social network state list page of the social networking state function. Specifically, the social network state list page is displayed in the social networking application. The social network state list page includes at least one option related to the social networking state. In a case that the target option on the social network state list page is triggered in a first selection mode, the target social networking state mark is displayed on the social networking page according to the target option. The first selection mode may include any one or more of tapping, double tapping, touching and holding, or other operating modes.

In an embodiment, the target social networking state mark may be any one or more of the following forms: an icon+a text description, a text description, an icon, and the like. The icon and the text description may be obtained based on the target option, and methods for determining the icon and the text description are different for different target options. The content of the part is specifically described in the following embodiments.

In an embodiment, the social network state list page is displayed in the social networking application after an enabling operation of enabling the social network state list page is received. The enabling operation may mean that the target user taps, touches and holds, or double taps a social networking state display area. For example, assuming that the social networking application is QQ, the social network state list page is displayed after the target user inputs the enabling operation into the social networking state display area in the message page of QQ.

In an embodiment, the options related to the social networking states may include at least one social networking state option and a trigger option, and the social networking state is identified in the target identification mode when the trigger option is triggered. Each social networking state option corresponds to a social networking state. In a case that the trigger option is selected, the message processing device automatically or intelligently identifies the current social networking state of the target user according to current location information and/or movement information of the target user. The target identification mode may be automatic identification or intelligent identification.

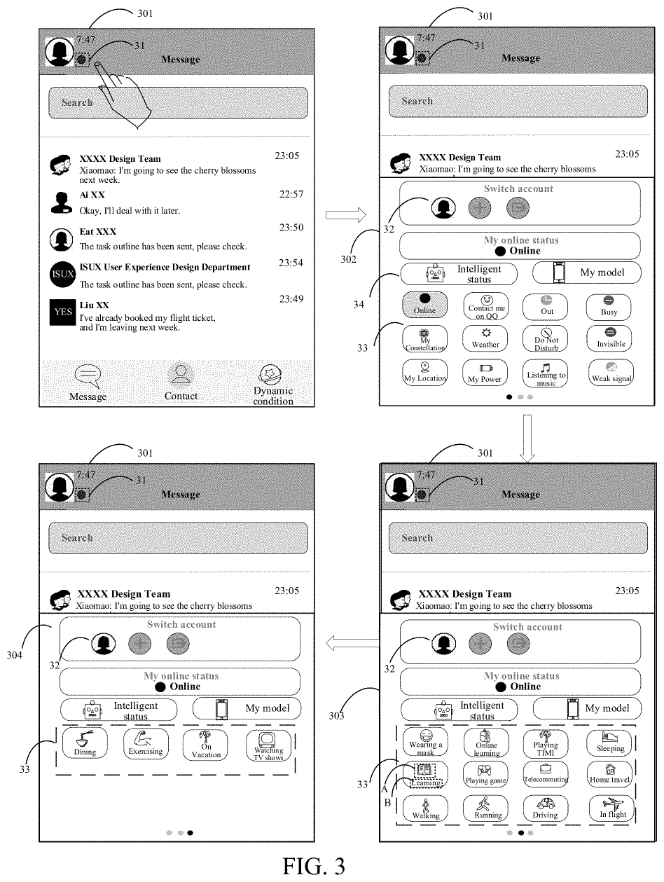

For example, FIG. 3 is a schematic diagram of a social network state list page according to an embodiment of the present disclosure, where 301 represents a message page, and 31 represents a social networking state display area. After the target user taps the social networking state display area 31, a social network state list page 302 is displayed on the social networking page. The social network state list page 302 may include other user accounts 32 associated with the user account of the target user and a plurality of options related to the social networking states, for example, a plurality of social networking state options 33 and a trigger option 34 that is triggered to identify the social networking state in the target identification mode. The social network state list page may include a plurality of pages. A specific number of social networking state options may be displayed on each page, and all social networking state options may be viewed by sliding to turn the page. For example, when the target user slides to turn a page in the social network state list page 302, the social networking state options in the social network state list page are shown in 303; and when the target user continues to turn the page, the social networking state options in the social network state list page are shown in 304.

In an embodiment, after the target user selects the target option, the target social networking state mark may be displayed on the social networking page according to the target option.

In an embodiment, when a target option selected on the social network state list page is a trigger option that is triggered to identify the social networking state in the target identification mode, the displaying the target social networking state mark on the social networking page according to the target option includes: displaying, on the social networking page, a mark of a social networking state matching current information of the target user as the target social networking state mark when the matched social networking state exists in the social networking state corresponding to the option related to the social networking state, the current information including at least one piece of current location information or current operation information; and determining the current social networking state of the target user according to the current information of the target user, and displaying the target social networking state mark on the social networking page according to the current social networking state, when the social networking state matching the current information of the target user does not exist in the social networking state corresponding to the option related to the social networking state.

In short, when the target user selects the trigger option, and the social networking state is identified in the target identification mode when the trigger option is triggered, the message processing device automatically detects whether the current location information and/or movement information of the target user matches the social networking state indicated by one social networking state option in the social network state list page. In a case that the matched social networking state is detected, the matched social networking state mark is displayed on the social networking page as the target social networking state mark. For example, when it is detected, according to the current location information and movement information of the user, that the target user is driving, and a social networking state matching driving exists in the social networking state page list, the matched social networking state mark is used as the target social networking state mark.

If no matched social networking state is detected, the message processing device determines the current social networking state of the target user according to the current location information and/or movement information, for example, determines that the target user may be by the sea according to the current location information and movement information, and then generates a target status mark according to the current social networking state.

In an embodiment, it can be seen from FIG. 3 that each social networking state option corresponds to an icon of a social networking state and a text description of the social networking state. In other embodiments, each social networking state option may also include only an icon or only a text description, which is not specifically limited in the embodiment of the present disclosure. Based on this, in order to facilitate the identification by the user, for a representation form of each social networking state mark, reference may be made to a representation form of the corresponding social option. That is, each social networking state mark may also include any one or more of the social networking state icon and the text description.

For example, it is assumed that the social networking state that matches the current location information and/or movement information of the target user is detected as “Walking” in the social network state list page, the message processing device uses the social networking state mark corresponding to the social networking state of “Walking” as the target social networking state mark. The representation form of the social mark corresponding to “Walking” may include any one or more of the following: “a Walking icon: Walking”, “a walking icon”, “Walking”, or other variations based on Walking and the Walking icon.

In other embodiments, when the target option selected on the social networking state page is the target social networking state option in a plurality of options related to the social networking states, the displaying the target social networking state mark on the social networking page according to the target option includes: determining the target social networking state mark according to a target social networking state corresponding to the target social networking state option, and displaying the target social networking state mark on the social networking page.

It may be learned from the foregoing that the social networking states corresponding to the options related to the plurality of social networking states in the social network state list page may be divided into different types of social networking states according to the different types of social networking states. Specifically, the social networking states may include a first type of social networking state, a second type of social networking state, a third type of social networking state, and other types of social networking states.

In an embodiment, the first type of social networking state may be represented as “My Location”. The first type of social networking state is a social networking state of the target user at a moment determined in real time according to the location information of the target user at the moment. Assuming that the current location information of the target user is “XXX office building in Chongqing”, then the current social networking state of the target user is “XXX office building in Chongqing”. For another example, the current location information of the target user is: “Shenzhen XX Fitness Center”, and then the current social networking state of the target user is “Shenzhen XX Fitness Center”.

In an embodiment, the second type of social networking state may be any social networking state related to work or study, such as “Working”, “Learning”, “In a Meeting”, “In Class”, or the like.

In an embodiment, the third type of social networking state may be a social networking state that is a current social networking state of the target user determined according to any one or more of weather information, date information, and a message processing device status. For example, the third type of social networking state may include “Horoscope”, “My Weather”, “My Power”, and the like. For example, “Horoscope” is a social networking state of the target user on one day determined according to date information. For another example, “My Power” is a social networking state of the target user determined according to the status of the message processing device.

It is to be understood that the first type of social networking state and the third type of social networking state dynamically change, and the second type of social networking state is static. That is, the second type of social networking state does not vary with the current location information, movement information, or other information of the user. The other types of social networking states may be other static social networking states except the second type of social networking state such as “On Vacation”, “On leave”, “Dining”, “Do Not Disturb”, and the like.

In an embodiment, when the target social networking state is the first type of social networking state, the determining the target social networking state mark according to the target social networking state corresponding to the target social networking state option, and displaying the target social networking state mark on the social networking page includes: determining, by the message processing device, the target social networking state mark according to any one or more of the current location information of the target user and a first type of social networking state mark, and displaying the target social networking state on the social networking page. The first type of social networking state mark may be determined according to an icon of the first type of social networking state. Alternatively, the first type of social networking state mark may be determined according to the icon of the first type of social networking state and a text description of the first type of social networking state. For example, assuming that the text description of the first type of social networking state is “My Location”, the first type of social networking state mark may be “Location Icon: My Location”. Alternatively, the first type of social networking state mark may further be “Location Icon”. Based on the foregoing description, assuming that the current location information is Nan'an District, Chongqing, the target social networking state mark may include one or more of the following forms: “Location Icon: Nan'an District, Chongqing”, “Location Icon: My Location: Nan'an District, Chongqing”, “My Location: Nan'an District, Chongqing”, “Nan'an District, Chongqing”, and “Location Icon: My Location”. It is to be understood that only several possible forms of the target social networking state mark are listed, and other combinations based on “Location Icon”, “My Location”, and the current location information all falls within the protection scope of this embodiment.

In an embodiment, when the target social networking state is the second type of social networking state, the determining the target social networking state mark according to the target social networking state corresponding to the target social networking state option, and displaying the target social networking state mark on the social networking page includes: displaying, by the message processing device, a second type of social networking state mark as the target social networking state mark on the social networking page. In the same way as the foregoing description, the second type of social networking state mark may also be determined according to any one or more of the icon of the second type of social networking state and the text description of the second type of social networking state. For example, when the text description of the second type of social networking state is “Learning”, the second type of social networking state mark may be “Learning Icon: Learning”, or may be “Learning”.

In an embodiment, a third type of social networking state mark being horoscope is used as an example. In a case that the target social networking state is the third type of social networking state, how to display the target social networking state mark on the social networking page of the social networking application is specifically described. During specific implementation, the message processing device determines the target social networking state mark according to any one or more of the third type of social networking state mark and the current horoscope, and displays the target social networking state mark on the social networking page. The third type of social networking state mark may be determined according to any one or more of the icon of the third type of social networking state, the text description of the third type of social networking state, an icon of a constellation of the target user, and the text description of the constellation of the target user. For example, the text description of the third type of social networking state is “Horoscope”. In a case that the text description of the constellation of the target user is Capricornus, and the icon of Capricornus is XXX, then the third type of social networking state mark is “XXX Capricornus”. Alternatively, the third type of social networking state mark may be “Horoscope Icon: Capricornus”.

In an embodiment, the current horoscope is determined according to current date information, and the current horoscope may be expressed as Appropriate to do xxx today or Inappropriate to do xx today, a description of the working condition today, a description of mood today, or the like. In an embodiment, the target social networking state determined by the message processing device according to the third type of social networking state mark and the current horoscope may be “Capricornus icon: Appropriate to give a gift today”. Alternatively, the target social networking state may be “Capricornus icon: Capricornus|Appropriate to give a gift today”. The foregoing are only two possible situations of the target social networking state listed in the embodiments of the present disclosure. In practical application, the target social networking state mark may be set according to requirements.

In an embodiment, when the target social networking state is other types of social networking states, the determining the target social networking state mark according to the target social networking state indicated by the target social networking state option, and displaying the target social networking state mark on the social networking page includes: displaying, by the message processing device, other types of social networking state marks as the target social networking state mark on the social networking page. In the same way as the foregoing description, the other types of social networking state marks may be determined according to any one or more of other types of social networking state icons and text descriptions of the other types of social networking states.

Step S202: Display a target message related to a trigger event matching the target option in the social networking application when the trigger event is detected based on an update to at least one parameter of the mobile device.

In an embodiment, the trigger event corresponding to the target option may be determined according to a setting of the target user in a configuration window corresponding to the target option, and different target options correspond to different trigger events. The target message may be used for reminding the target user to execute some events or reminding the target user to perform some input operations to display the target social networking state mark on the social networking page. Moreover, the target message may alternatively be some conversation notification messages in the social networking application. The content of this part is to be specifically described in the following embodiments.

In the prior art, the social network state list page includes a social networking state option, but does not include the trigger option triggered to identify the social networking state in the target identification mode. The target option selected by the user on the social network state list page is the social networking state option. After the user selects the social networking state option, the message processing device only switches the current social networking state of the user to the social networking state indicated by the social networking state option, and does not perform further social interaction operations. However, in the embodiment of the present disclosure, the social network state list page further includes the trigger option triggered to identify the social networking state in the target identification mode. The identification of the social networking state in the target identification mode can implement more accurate matching of the social networking state of the target user. After the user selects the target option, the message processing device may not only display the target social networking state according to the target option, but also detect the trigger event matching the target option, thereby displaying the target message. In this way, the social networking state is not only used for showing the current online state of the user, but also associated with the trigger event and the target message, thereby improving the interaction between the user and the social networking state function, enriching the social networking state function, and increasing the attention of the social networking application.

In the embodiment of the present disclosure, the target social networking state mark of the target user is displayed on the social networking page of the social networking application. The social networking state mark is used for representing the current social networking state of the target user, and the target social networking state mark is determined according to a selected target option related to the social networking state. The message processing device displays the target message related to the trigger event matching the target option in the social networking application when it is detected that the trigger event is detected based on an update to at least one parameter of the mobile device. In the foregoing process, after the user selects the target option related to the social networking state, the message processing device detects the trigger event related to the target option set by the user, to further display the target message related to the trigger event. In this way, it indicates that the option related to the social networking state set by the user may be associated with the trigger event and the target message. As a triggering condition of displaying the target message, compared with the social networking state only used for displaying the current online state of the user in the prior art, the interaction between the user and the social networking state function is increased, and the social networking state function is enriched, thereby increasing the attention of the social networking application.

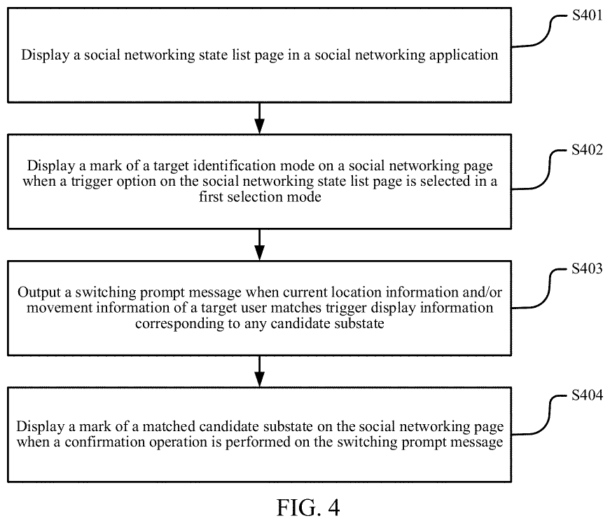

Based on the foregoing message processing method, an embodiment of the present disclosure further provides another message processing method. FIG. 4 is a schematic flowchart of another message processing method according to an embodiment of the present disclosure. In the message processing method shown in FIG. 4, the target option is a trigger option triggered to identify the social networking state in the target identification mode. The message processing method shown in FIG. 4 may be performed by a message processing device, and may specifically be performed by a processor of the message processing device. The message processing method shown in FIG. 4 may include the following steps.

Step S401: Display the social network state list page in the social networking application, the social network state list page including a trigger option, and the social networking state is identified in the target identification mode when the trigger option is triggered.

Step S402: Display a mark of the target identification mode in the social networking application when the trigger option in the social network state list page is triggered in a first selection mode.

In an embodiment, in the embodiment shown in FIG. 4, the foregoing target option is the trigger option triggered to identify the social networking state in the target identification mode. The target identification mode corresponds to at least one candidate substate, and each candidate substate corresponds to trigger display information. The trigger display information includes at least one piece of location information or movement information. The displaying a target social networking state mark on a social networking page of a social networking application includes: displaying the mark of the target identification mode on the social networking page; and displaying a mark of any matched candidate substate on the social networking page when current information of the target user matches the trigger display information corresponding to the candidate substate, the current information including at least one piece of current location information or current operation information.

The identification of the social networking state in the target identification mode may also be referred to as an intelligent status or an automatic identification status. The trigger display information corresponding to the candidate substate is used for using the candidate substate as the current social networking state of the target user when the movement information and/or the location information of the target user matches the corresponding movement information and/or location information in the trigger display information. In short, when the trigger option is selected, the social networking state of the target user at a moment is determined according to the location information and/or the movement information at the moment and the trigger display information of each designated candidate substate.

In other words, the target identification method corresponds to at least one candidate substate. After the target user sets the trigger option selected to identify the social networking state in the target identification mode, the message processing device continuously acquires the current location information and/or movement information of the target user, and matches the acquired location information and/or operation information with the trigger display information of each candidate substate. In a case that a matched candidate substate is found, the candidate substate is determined as the current social networking state of the target user.

After the target user selects the target option, the message processing device may display the mark of the target identification mode on the social networking page before finding the matched candidate substate. The mark identified in the target identification mode causes the target user and the contact user of the target user to learn that the target user has enabled the identification of the social networking state in the target identification mode. The contact user may further identify the social networking state as a conversation topic in the target identification mode, and start a conversation with the target user, for example, discuss advantages and disadvantages of identifying the social networking state in the target identification mode, or some problems encountered during the identification of the social networking state in the target identification mode, or the like. In a case that the message processing device finds the matched candidate substate, the matched candidate substate mark may be displayed on the social networking page instead of the mark of the target identification mode.

In other embodiments, after the target user selects the target option, the message processing device may further display the mark of a specified social networking state on the social networking page before finding the matched candidate substate. The specified social networking state may be set for the target user. Alternatively, the specified social networking state may further be the social networking state before the target user selects the target option. Still alternatively, the specified social networking state may further be a default social networking state of the message processing device. For ease of description, in the following description, unless otherwise specified, after the target user selects the target option, the target social networking state mark displayed by the message processing device is the mark of the target identification mode before the message processing device finds the matched candidate substate.

In an embodiment, the current location information of the target user may be determined according to location data such as a longitude, a latitude, and an altitude, and the like of the current location of the target user. The movement information may be determined based on movement data acquired by a motion sensor in the message processing device.

In an embodiment, the implementation of acquiring the current location information of the target user may be: acquiring, by the message processing device, the longitude, the latitude, and the altitude where the current target user is located; transmitting the longitude, the latitude, and the altitude a map software development kit; and obtaining point of information (POI) coordinates by using the map software development kit (SDK) according to the longitude, the latitude, and the altitude, the POI coordinates being used as the location information.

In an embodiment, the possible implementation of acquiring the current movement information of the target user may be: acquiring, by the message processing device, the movement data acquired by the motion sensor in the message processing device, such as a step number, a speed, and the like; and collecting the location information according to the movement data to acquire the current operation information of the target user, such as walking, running, driving, in flight, and the like.

In an embodiment, the at least one candidate substate included in identifying a social networking state in the target identification mode may be selected in a configuration window corresponding to the social networking state identified in the target identification mode. Specifically, after the trigger option in the social network state list page is triggered in a second selection mode, a configuration window for identifying the social networking state in the target identification mode is displayed. The configuration window includes at least one substate. At least one candidate substate is selected from the substates. In other words, at least one substate selected by the target user in the configuration window is used as the candidate substate.

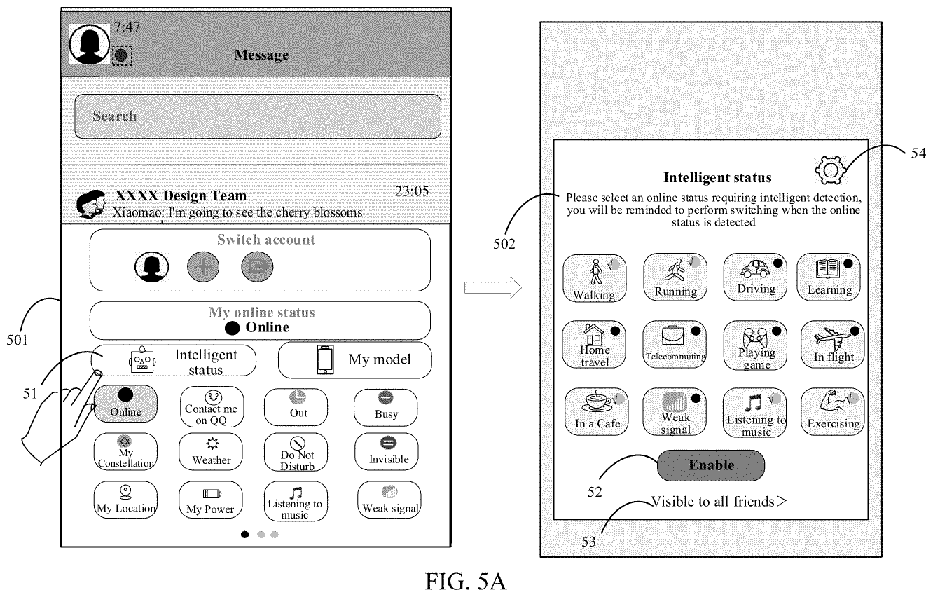

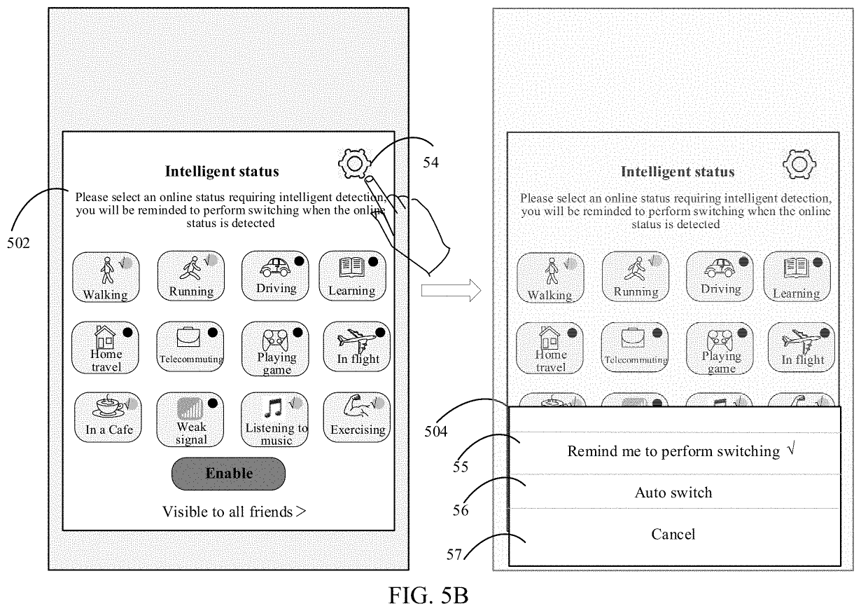

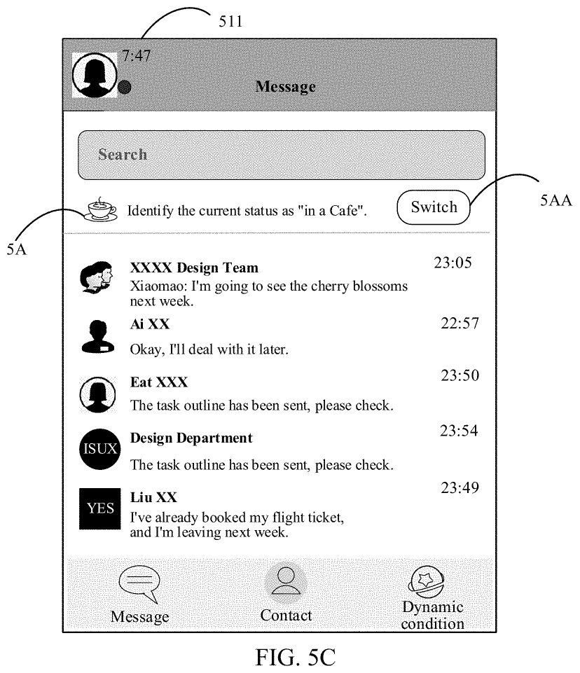

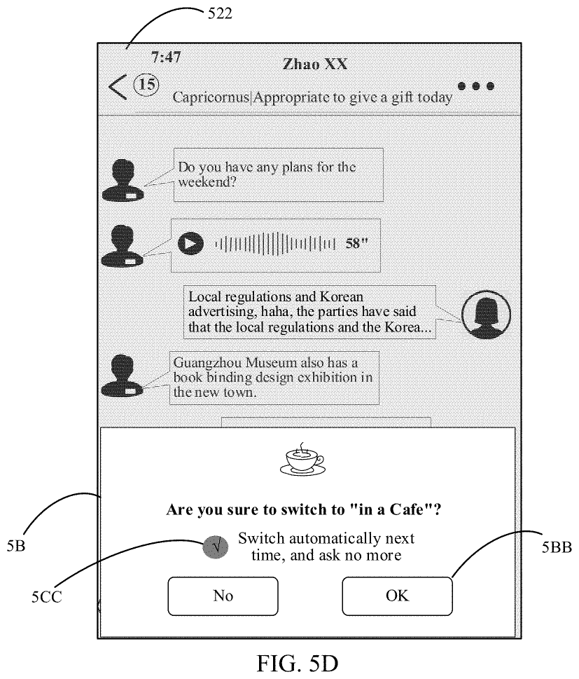

For example, FIG. 5A is a schematic diagram of setting a candidate substate according to an embodiment of the present disclosure. In FIG. 5A, 501 represents a social network state list page, and 51 represents a trigger option for identifying the social networking state in an automatic identification mode. After the target user selects 51, the message processing device is triggered to display a configuration window 502 for identifying the social networking state in the target identification mode. The configuration window 502 may include a plurality of substates, such as “walking”, “running”, “driving”, “in a cafe”, and the like. Each substate may correspond to a check box. In a case that any substate is not selected, the check box is empty and displayed in a first color. In a case that any substate is selected by the user, a preset icon such as √ appears in the check box, and is displayed in a second color. In this way, the target user may clearly learn, from changes in the check box, which substates have been selected and which substates have not been selected. In a case that the target user finds that one substate has been selected by mistake, the selection of the substate may be canceled in time. Assuming that the target user selects “walking”, “running” and “in a cafe” in 502, the three substates are used as candidate substates included in the social networking states identified in the target identification mode.

In an embodiment, the configuration window may further include an enable control 52. The target user may select the enable control 52 after selecting at least one candidate substate in the foregoing configuration window, to save the at least one selected candidate substate. In this way, it is convenient for the message processing device to select the matched candidate substate from at least one candidate substate according to the current location information and/or the movement information of the target user, thereby displaying the candidate substate mark.

The configuration window may further include a friend permission setting option 53, so that the target user may set, by means of 53, which friends having permission to view the social networking state and which friends not having permission to view the social networking state.

Step S403: Output a switching prompt message when the current location information and/or movement information of the target user matches the trigger display information corresponding to any one of the candidate substates.

In an embodiment, in order to improve user experience, when the message processing device detects a candidate substate matching the current location information and/or movement information of the target user, the switching prompt message may be outputted to remind the target user that the first type of social networking state mark may be switched to the matched candidate substate mark. Whether to perform the switching is determined by the target user.

In an embodiment, the switching prompt message is outputted when the switching mode corresponding to the social networking state is identified in the target identification mode is used for prompting the user to perform switching. That is to say, the switching prompt message is required to be outputted before step S402 is performed only when the switching mode preset by the target user is used for prompting the user to perform switching.

In other embodiments, when the switching mode corresponding to the first type of social networking state is the automatic switching, there is no need to output the switching prompt message. After the candidate substate matching the current location information and/or movement information is detected, the matched candidate substate mark is directly displayed instead of the first type of social networking state mark.

In an embodiment, the switching mode corresponding to the social networking state identified in the target identification mode may be the default of the system. Alternatively, the switching mode corresponding to the social networking state identified in the target identification mode may also be set by using the configuration window corresponding to the social networking state identified in the target identification mode. During the specific implementation, the configuration window for identifying the social networking state in the target identification mode may further include a configuration control. The configuration control is configured to trigger, when the candidate substate matching the current location information and/or the movement information is found, a switching mode to display the matched candidate substate mark instead of the mark the social networking state identified in the target identification mode.

A mode switching prompt box is displayed when the configuration control is triggered. The mode switching prompt box includes a first mode switching option and a second mode switching option. In a case that the first switching mode in the mode switching prompt box is triggered, the switching prompt message is outputted before the matched candidate substate mark is displayed. The first switching mode may be to prompt the user to perform switching, and the second switching mode may be automatic switching.

FIG. 5B is a schematic diagram of a configuration switching mode according to an embodiment of the present disclosure. The configuration window 502 in FIG. 5A may include a configuration control 54. In a case that the target user selects the configuration control 54, the configuration control 54 is selected to trigger displaying of the mode switching prompt box. As shown in 504 in FIG. 5B, 504 may include a first mode switching option, expressed as 55 in FIG. 5B: “prompt me to perform switching”, and 504 may further include a second mode switching option, expressed as 56 in FIG. 5B: “automatic switching”. In an embodiment, 504 may further include a Cancel option 57. The target user may return to the configuration window 502 by taping 57.

Step S404: Display the matched candidate substate mark on the social networking page when a confirmation operation is performed on the switching prompt message.

In an embodiment, the switching prompt message may include a confirmation option. In a case that the target user selects the confirmation option, the message processing device determines that the confirmation operation is performed on the switching prompt message, and then displays the matched candidate substate mark on the social networking page.

It can be learned from the foregoing that the social networking page includes a status interface and a conversation interface. The switching prompt message is displayed on the conversation interface in a first display mode, and the first display mode may include a half-screen pop-up window display mode. The switching prompt message is displayed on the status interface in a second display mode, and the second display mode includes a small horizontal bar display mode.

FIG. 5C is a schematic diagram of displaying a switching prompt message according to an embodiment of the present disclosure. 511 represents a status interface, 5A represents a switching prompt message, and 5A is displayed on the social networking page in a form of the small horizontal bar. The switching prompt message 5A may include a confirmation option 5AA, which is represented as a “Switch” button.

FIG. 5D is a schematic diagram of displaying another switching prompt message according to an embodiment of the present disclosure. 522 represents a conversation interface for a conversation between the target user and a second user, 5B represents the switching prompt message, and 5B is displayed in 522 in the form of the half-screen pop-up window. The switching prompt message 5B may include a confirmation option 5BB, which is represented as an “OK” button. In an embodiment, the switching prompt message 5B may further include an option 5CC of “automatically switch next time, never ask again”. In a case that the target user selects the 5CC option, and it is detected that the location information and/or the movement information of the target user matches the candidate substate next time, the candidate substate mark may be directly displayed on the social networking page without outputting the switching prompt message.

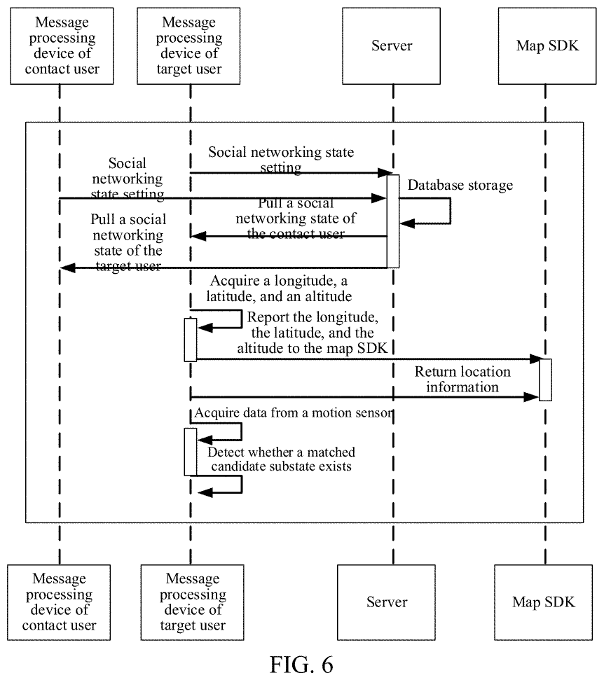

It may be learned from the foregoing that in order to implement the identification of the social networking state in the target identification mode, it is necessary to rely on the operation information and/or the location information collected by the message processing device used by the target user, and data, stored in the server and set by the target user, related to the social networking state identified in the target identification mode. An interaction flow between the message processing device used by the target user and the server during the implementation of identifying the social networking state in the target identification mode is described below by using FIG. 6. FIG. 6 is a flowchart of interaction between a message processing device and a server according to an embodiment of the present disclosure.

In an embodiment, the target user performs social networking state setting by using a social networking application running in the message processing device. Specifically, a trigger option of identifying the social networking state in the target identification mode is triggered in a second selection mode, a configuration window corresponding to the social networking state identified in the target identification mode is displayed, and a plurality of candidate substates are selected in the configuration window. In addition, a switching mode may further be set in the configuration window. The message processing device notifies the server that the target user has set identification of the social networking state in the target identification mode, and transmits the plurality of selected candidate substates to the server. The social networking state identified in the target identification mode and the plurality of candidate substates are stored in the server. For the server, the automatic social networking state set by the target user is a field in a database, and the field and a user account of the target user form a mutual mapping relationship.

In this way, even if the target user logs in to the social networking application on the new message processing device by using the user account, the server may still normally display, according to the stored data, the social networking state previously set by the target user in the new message processing device.

In addition, for the contact user of the target user, the message processing device used by the contact user may pull the social networking state of the target user from the server according to a pull protocol. Specifically, the message processing device used by the contact user may transmit the user account of the target user to the server. The server may acquire the social networking state set by the target user according to the user account of the target user, and return the social networking state of the target user to the social networking application used by the contact user. In this way, the contact can view the social networking state of the target user to introduce more interactive topics based on the social networking state. Similarly, the social networking application used by the target user may also pull the social networking state of the contact user from the server according to the pull protocol.

In an embodiment, after the target user selects the target option triggered to identify the social networking state in the target identification mode, the message processing device used by the target user continuously detects the location information and/or the movement information, to determine whether the current location information and/or the movement information of the target user matches any one of the candidate substates.

In an embodiment, the location detection may include: acquiring a longitude, a latitude, and an altitude where the social networking application is located; reporting the acquired longitude, latitude and altitude to the SDK, such as Tencent Map SDK; and obtaining POI coordinates according to the longitude, the latitude, and the altitude by using the map SDK, the POI coordinates being used as the location information.

The movement information detection may include: acquiring a value of a motion sensor of the social networking application, the value of the motion sensor including information such as a movement speed and a number of movement steps of the target user within a period of time; and implementing, by the social networking application, an intelligent detection algorithm, determining, by using the movement speed and the number of steps, whether the target user is running or walking, and synchronizing rates of change in the longitude and the latitude to determine whether the target user is driving.

In the embodiment of the present disclosure, after the target user selects the trigger option triggered to identify the social networking state in the target identification mode, the message processing device may display a mark of the social networking state identified in the target identification mode on the social networking page. In a case that it is detected that the current location information and/or movement information of the target user matches any one of the candidate substates, the switching prompt message is outputted, so as to remind the target user whether to display the matched candidate substate mark on the social networking page instead of the mark of the social networking state identified in the target identification mode. In the above message processing process, the target user may select a trigger option, so that the message processing device can automatically switch the current social networking state of the target user according to different location information and/or movement information of the target user, thereby enriching the setting mode of the social networking state. In addition, the message processing device may further output a switching prompt message before the switching, and whether to perform switching is determined by the target user, which avoids random switching without the knowledge of the target user, thereby improving user experience.

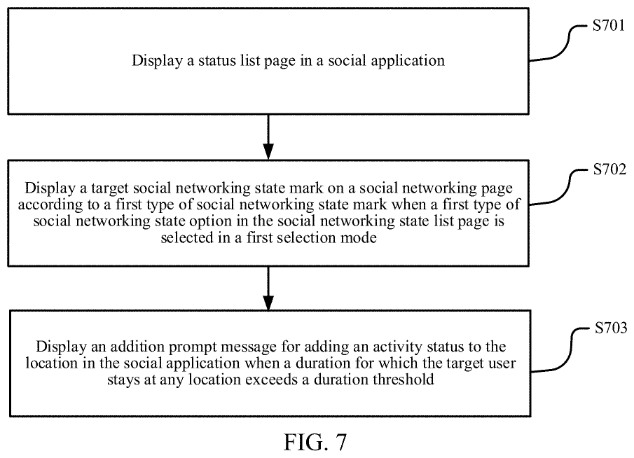

Based on the foregoing message processing system, an embodiment of the present disclosure provides another message processing method. FIG. 7 is a schematic flowchart of another message processing method according to an embodiment of the present disclosure. In the message processing method shown in FIG. 7, the target social networking state is a first type of social networking state. The trigger event includes that a duration for which the target user stays at any location exceeds a duration threshold, and the target message includes an addition prompt message for prompting addition of an activity state to the location. The method is described below by using step S701 to step S703.

Step S701: Display a social network state list page in a social networking application.

Step S702: Display a target social networking state mark on the social networking page according to a first type of social networking state mark when a first type of social networking state option in the social network state list page is triggered in a first selection mode.

It may be learned from the foregoing that the first type of social networking state may be the “My Location” social networking state. In such a social networking state, the message processing device detects the current location information of the target user at every moment. The displaying the target social networking state mark on the social networking page according to the first type of social networking state mark may include: determining the target social networking state mark according to any one or more of the current location information and the first type of social networking state mark, and displaying the target social networking state mark on the social networking page. For example, a text description of the first type of social networking state is “My Location”, and the first type of social networking state mark may be represented as “Location Icon: My Location”. Assuming that the current location information of the target user is XX Office Building in Nan'an District, Chongqing, the target social networking state mark displayed on the social networking page may be “Location Icon: XX Office Building, Nan'an District, Chongqing”. Alternatively, the target social networking state mark may further be “Location Icon: My Location: XX Office Building, Nan'an District, Chongqing”. Still alternatively, the target social networking state mark may further be “XX Office Building, Nan'an District, Chongqing”.

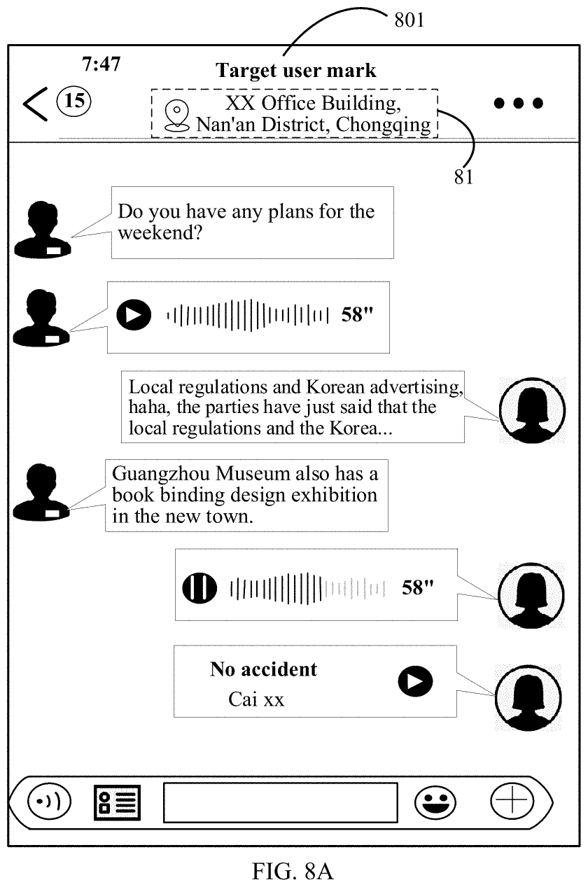

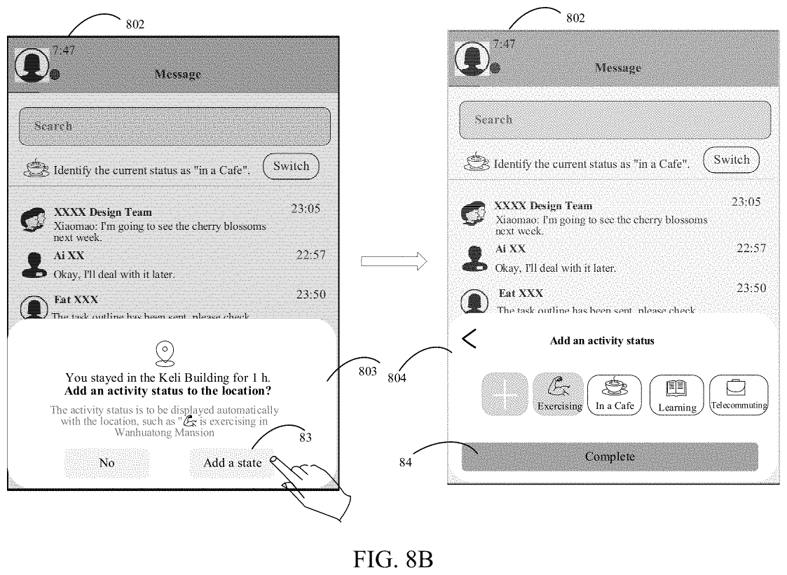

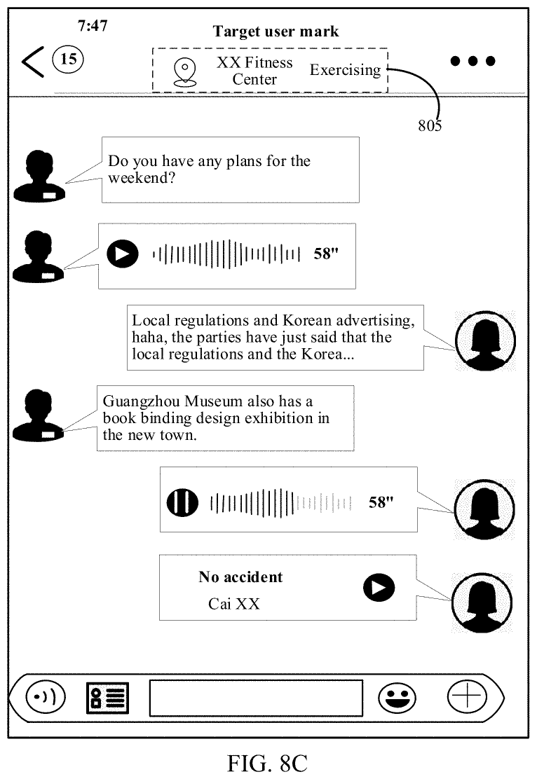

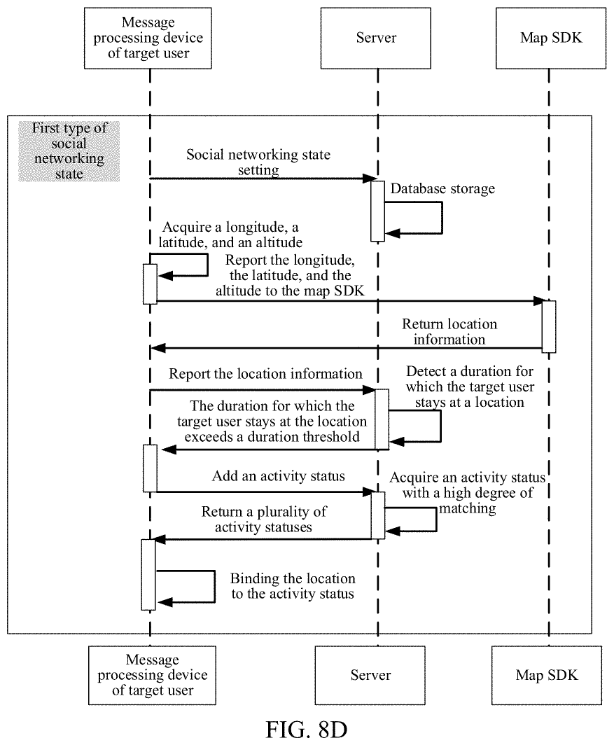

For the contact user of the target user, for the foregoing target social networking state mark displayed in the conversation interface (the target social networking state mark of the target user is displayed in the social networking application used by the contact user, which may be referred to as a guest mode, and the target social networking state mark is displayed in the social networking application used by the target user, which may be referred to as a master mode) between the contact user and the target user, reference may be made to FIG. 8A. FIG. 8A is a schematic diagram of a conversation interface shown by a contact user according to an embodiment of the present disclosure. FIG. 8A is a conversation interface between the contact user and the target user displayed on the social networking application of the contact user. The conversation interface may include a mark 801 of the target user, and the mark may be a user account used by the target user to log in to the social networking application, or may be a nickname set by the contact user for the target user. 81 represents the target social networking state mark.

In an embodiment, in the guest mode, the target social networking state mark 81 may be displayed in a top area of the conversation interface. During specific implementation, 81 may be displayed below 801, for example, 81 is represented as: “Location Icon: XX Office Building, Nan'an District, Chongqing”. The positional relationship between 81 and 801 is not limited to the above. In practical application, 81 may also be displayed above 801, or 81 may be located on a left side or a right side of 801.

In another embodiment, in the guest mode, the target social networking state 81 may also be displayed in the conversation area. In a specific implementation, the target social networking state may be displayed around the location identified by the target user in the conversation area.

In other embodiments, in the guest mode, the target social networking state 81 may also be displayed at any other location in the conversation interface.

Displaying the target social networking state mark of the target user in the guest mode may cause the contact user and the target user to find more interaction topics by using the target social networking state. For example, when the contact user notices that it will rain in Chongqing tonight, the contact user can remind the target user that it will rain in Chongqing tonight, and to remember to bring an umbrella when going out.

Step S703: Display an addition prompt message for adding an activity state to the location in the social networking application when a duration for which the target user stays at any location exceeds a duration threshold.

In an embodiment, the message processing device detects the current location information of the target user in real time, so as to update the target social networking state in time when the location of the target user changes.

During the detection of the current location information of the target user, when it is found that the duration for which the target user stays at a location exceeds the duration threshold by 1 hour, the message processing device may push the addition prompt message of the activity state to the target user. The addition prompt message may include an addition confirmation option, and the target user can bind an activity state to the location with by triggering the addition confirmation option.

During the specific implementation, the addition confirmation option included in the addition prompt message is selected to trigger displaying of the activity state selection window. A target activity state selected in the activity interface selection window is bound to the location. After the binding, when the target user is at the location, and the target social networking state mark is displayed on the social networking page, the target activity state bound to the location is synchronously displayed.

The activity interface selection window may include a plurality of activity states with a high degree of matching with the location, and the plurality of activity states displayed in the activity state selection window may be transmitted by the server to the message processing device. Specifically, in order to detect the activity state matching a specific location at the specific location, the server is required to provide a service of recommending an activity state at the location in the social networking application. Therefore, the server is required to collect a large number of locations and a number of activity states. In a case that it is detected that the server is needed to recommended the activity state bound to the location in the social networking application, a recommendation algorithm (such as a collaborative filtering algorithm) is used for recommending some activity states with a relatively high hit rate (that is, a relatively high degree of matching) according to the current location of the target user detected by the social networking application.

The message processing device receives the activity state recommended by the server after pushing the current location information of the target user to the server, and displays the activity state in the activity state selection window. A single-selection and multiple-selection interaction mode is provided in the activity state selection window to bind the location to one or more activity states selected by the user.

FIG. 8B is a schematic diagram of binding a location to an activity state according to an embodiment of the present disclosure. In FIG. 8B, 802 represents a social networking page, and when the message processing device detects that a duration for which the target user stays at a location exceeds a duration threshold, an addition prompt message displayed on the social networking page is shown in 803. The target user taps the addition confirmation option 83 in the addition prompt message 803 to enter an activity state selection window 804. The activity state selection window 804 may include a plurality of activity states, and the activity state not selected by the target user is displayed in a first display color, such as white. The activity state selected by the target user is displayed in a second display color such as gray. It is assumed that the activity state selected by the target user is “Exercising”. The activity state selection window 804 may further include a Complete option 84. The target user may tap the Complete option 84 after selecting the target activity state, to complete binding the location of the target user to the activity state of “Exercising”.

After the binding, when the target user is in the location and the target social networking state mark is displayed, the target activity state is displayed synchronously. For example, assuming that the foregoing location is “XXX Fitness Center”, the target social networking state mark is “Location Icon: XXX Fitness Center”. For the contact user of the target user, when the target user is in the foregoing location, the target social networking state mark “Location Icon: XXX Fitness Center” is displayed in the conversation interface of the guest mode. At the same time, the target activity state “Exercising” is displayed as 805 in FIG. 8C.

It may be learned from the foregoing that, in order to push, to the target user at the location, the activity state that can be bound to a location, the server is required to provide a service that provides activity state push according to location information, and the message processing device is required to transmit the location information detected each time to the server. The interaction between the message processing device and the server during the implementation of the service of pushing the bound activity state to the target user at a location is described below by using FIG. 8D. FIG. 8D is a flowchart of interaction between a message processing device and a server.

In an embodiment, in order to implement the service of pushing the bound activity state service to the target user at a location, a large amount of location information and the number of activity states are stored in the server. After the target user selects the first type of social networking state by using the message processing device, the message processing device detects the current location information of the target user, and transmits the detected location information to the server.

In an embodiment, the duration for which the target user stays at the location may be counted by the message processing device. In this case, when the message processing device detects that the duration for which the target user stays at the location exceeds the duration threshold, and reports the location information to the server, an addition prompt message for adding the activity state to the location is displayed in the message processing device. In a case that the target user inputs the confirmation addition operation for the addition prompt message, the message processing device may instruct the server to acquire an activity state having a relatively high degree of matching with the location and return.

The server uses the recommendation algorithm (such as the collaborative filtering algorithm) to select the activity state with a relatively high hit rate according to the location information reported by the message processing device, and returns the selected activity state to the message processing device. The message processing device displays the received activity state in the activity state selection window for the target user to select.

In other embodiments, the duration for which the target user stays at the location may also be counted by the server. In this case, after the message processing device reports the location information detected in real time to the server, the server counts the duration for which the target user stays at the location. In a case that it is detected that the duration for which the target user stays at the location exceeds the duration threshold, the message processing device is instructed to display the addition prompt message. Further, the message processing device instructs the server to return the activity state with a relatively high degree of matching according to the foregoing location after receiving the confirmation operation for the addition prompt message, and the message processing device displays the returned activity state on the activity state selection interface.

In an embodiment, the target user may select the target activity state on the activity state selection interface, and the message processing device may bind the target activity state to the foregoing location and store the binding relationship. In other embodiments, the message processing device may further upload the binding relationship to the server for storage.

In the embodiment of the present disclosure, the target social networking state mark is displayed on the social networking page according to the current location information of the target user and the first type of social networking state mark. In this way, the target user and the contact user of the target user may view the location of the target user, and create an interaction topic based on the location of the target user or send a care reminder according to a weather condition of the location of the target user. In addition, when the duration for which the target user stays at any location exceeds the duration threshold, the target user can be reminded to bind the location to the activity state, thereby enriching the social networking state function, and improving the utilization of the social networking application.

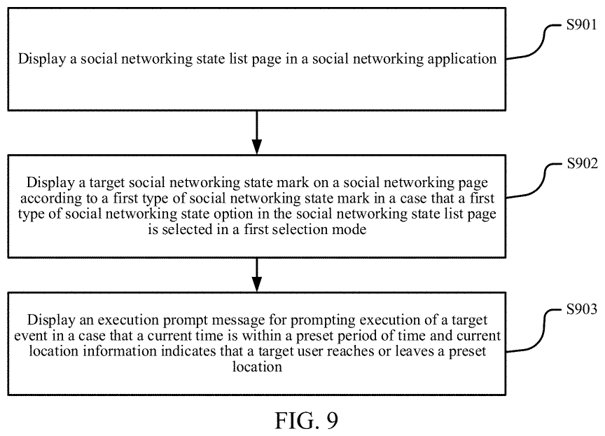

Based on the foregoing embodiments of the message processing method, an embodiment of the present disclosure provides still another message processing method. FIG. 9 is a schematic flowchart of a message processing method according to an embodiment of the present disclosure. In the message processing method described in FIG. 9, the target social networking state is a first type of social networking state. The trigger event includes that a current time is within a preset period of time and current location information conforms to a preset location condition of a target user. The preset location condition includes reaching the preset location or leaving the preset location, and the target message includes an execution prompt message for prompting execution of a target event. The method is specifically described below by using step S901 to step S903.

Step S901: Display a social network state list page in a social networking application.

Step S902: Display a target social networking state mark on the social networking page according to a first type of social networking state when the first type of social networking state in the social network state list page is triggered in a first selection mode.

In an embodiment, for the implementation of determining the target social networking state mark according to the first type of social networking state, reference may be made to the description of related steps in the embodiments of FIG. 2 and FIG. 7, and the details are not described herein again.

Step S903: Output an execution prompt message for prompting execution of a target event when a current time is within a preset period of time and current location information conforms to a preset location condition of the target user, the preset location condition including reaching the preset location or leaving the preset location.

In an embodiment, after the target user selects the first type of social networking state, the preset period of time, the preset location, the target event, and the like may be set in a configuration window corresponding to the first type of social networking state, to remind the target user to execute the target event when the target user reaches or leaves the preset location within the preset period of time.

Specifically, when the target user selects the first type of social networking state option in a second selection mode on the social network state list page, displaying of the configuration window corresponding to the first type of social networking state is triggered. The first selection mode and the second selection mode may be any two different operation modes among operations such as taping, double-taping, touching and holding, and the like. For example, the first selection mode is taping, and the second selection mode is touching and holding.

In an embodiment, the configuration window of the first type of social networking state may include a preset period of time setting item, a target event setting item, a preset location setting item, and an option of Arrived or Out. The target user sets the preset period of time by using the preset period of time setting item. For example, the preset period of time may be 8:00-11:00 from Monday to Friday. The preset location item is used for setting the preset location when being triggered, for example, the preset location is XX Building. The target event setting item is used for setting the target event to remind the target user to execute, and the target event may include events such as punching in, opening a QR code, and the like. The target event setting item may include a uniform resource locator (URL) of a public account of the target event, a hyperlink, or other identifiers that can enter the target event.

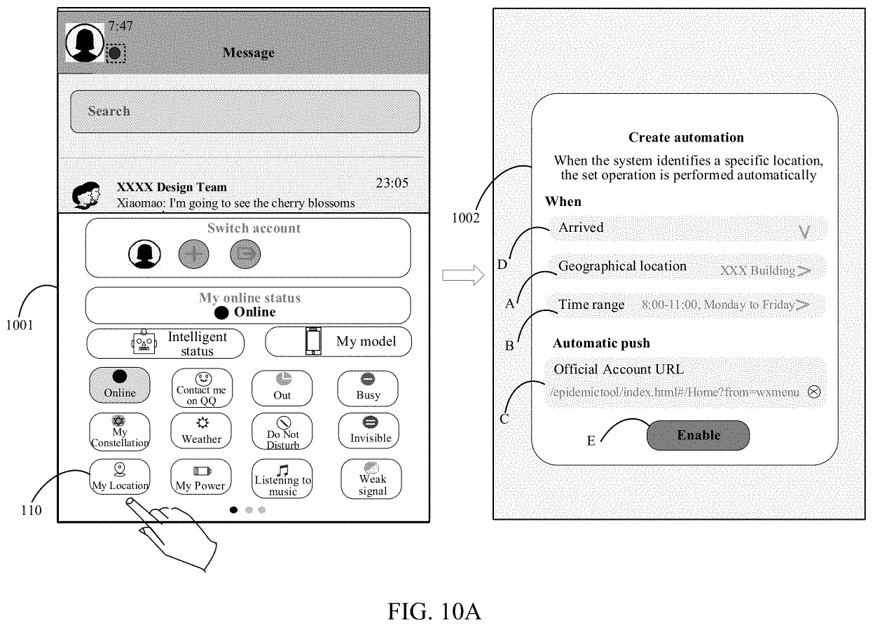

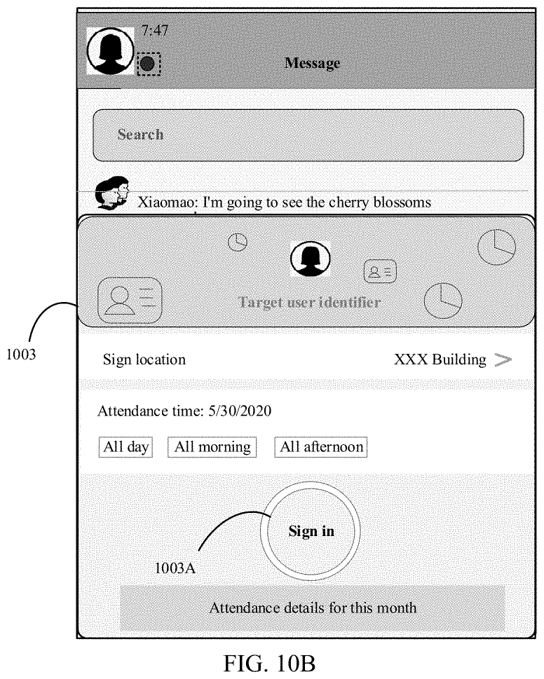

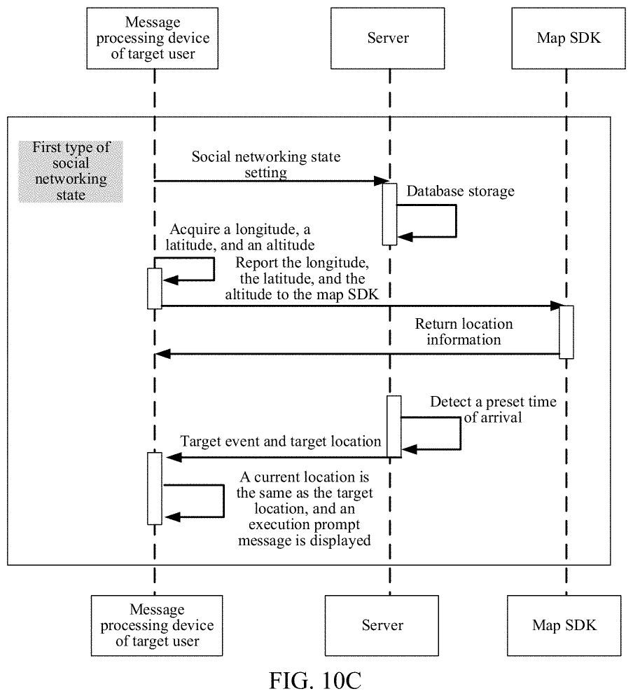

For example, FIG. 10A is a schematic diagram of configuring the first type of social networking state according to an embodiment of the present disclosure. In FIG. 10A, it is assumed that the first type of social networking state is My Location, and 1001 represents the social network state list page. In a case that the target user touches and holds the first type of social networking state option 110 in the social network state list page 1001, displaying of a configuration window 1002 corresponding to the first type of social networking state is triggered. 1002 may include a preset location setting item A, a preset period of time setting item B, a target event setting item C, and an option D of Arrived or Out. It is assumed that the target user sets the preset period of time as 8:00-11:00 from Monday to Friday, sets the preset location as “XXX Building”, and selects the option D of Arrived. An official account URL corresponding to the punch-in event is entered into the target event setting item C. The configuration window 1002 may include an option E Enable. Upon completion of the settings, the target user may choose to enable the option E to save the settings.

Upon completion of the settings, when it is detected that the current time is within the preset period of time, and the current location information indicates that the target user reaches or leaves the preset location, the execution prompt message for prompting the execution of the target event is outputted. The execution prompt message may include a preset location, a target user identifier such as a name of the target user, and an execution control for executing the target event. For example, FIG. 10B is a schematic diagram of displaying a target message according to an embodiment of the present disclosure. It is assumed that the target event set by the target user in FIG. 10A is to punch in when arriving at the XXX building within the period of time of 8:00-11:00 from Monday to Friday. In FIG. 10B, 1003 represents the target message, and a “Sign-in” button 1003A in the target message represents the execution control. In a case that the execution control 1003A is triggered, the sign-in for work is completed.

In order to implement the embodiment described in FIG. 9, for the interaction between the message processing device and the server, reference may be made to the interaction diagram shown in FIG. 10C.

In an embodiment, the target user may trigger the first type of social networking state in the second selection mode, and at this point, the message processing device displays the configuration window of the first type of social networking state. After the target user sets the preset location, the preset period of time, and the target event in the configuration window, and after the target event, the message processing device uploads the foregoing contents set by the target user to the server.

The server receives the contents uploaded by the message processing device and stores the contents in the database. Further, the server sets a timer program to detect whether the current time reaches the preset time. When it is detected that the current time is within the preset period of time, the target event and the preset location stored in the database are transmitted to the message processing device.

After receiving the target event and the preset location transmitted by the server, the message processing device may check whether the current location information is consistent with the preset location. In a case that the current location information is not consistent with the preset location, this can be ignored. In a case that the current location information is consistent with the preset location, the target message is displayed.

In the embodiment of the present disclosure, the target social networking state mark is displayed on the social networking page according to the current location information of the target user and the first type of social networking state mark. In this way, the target user and the contact user of the target user may view the location of the target user, and create an interaction topic based on the location of the target user or send a care reminder according to a weather condition of the location of the target user. In addition, when the target user reaches or leaves the preset location within the preset period of time, the message processing device may output the execution prompt message for reminding the user to execute the target event. In this way, the social networking state function is associated with the target event. The target event may be completed by the target user by using other applications, which improves the integration between the social networking application and other applications, and enriches the social networking state function.

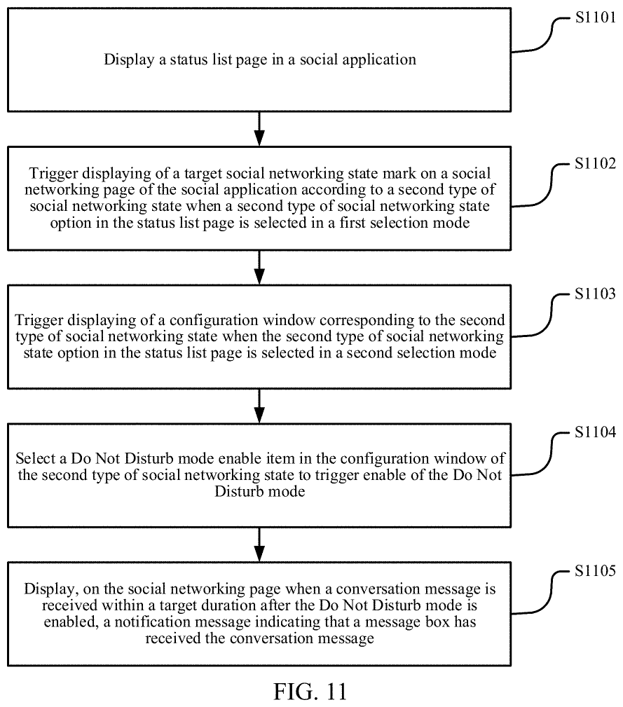

Based on the foregoing embodiments of the message processing method, an embodiment of the present disclosure provides still another message processing method. FIG. 11 is a schematic flowchart of a message processing method according to an embodiment of the present disclosure. In the message processing method described in FIG. 11, the target social networking state is a second type of social networking state. The trigger event includes receipt of a conversation message within a target duration after the Do Not Disturb mode is enabled in the social networking application, and the target message includes a notification message indicating that the message box receives the conversation message. The method is specifically described below by using step S1101 to step S1104.

Step S1101: Display a social network state list page in a social networking application.

In one embodiment, for some feasible implementations included in step S1101, reference may be made to the description of related steps in the foregoing embodiments, and the details are not described herein again.

Step S1102: Display a target social networking state mark on a social networking page of the social networking application according to the second type of social networking state when a second type of social networking state option in the social network state list page is triggered in a first selection mode.

It may be learned from the foregoing that the first selection mode and the second selection mode may be any two different operation modes of operations such as taping, double-taping, and touching and holding of the target user. It is assumed that the first selection mode is taping, and the second selection mode may be touching and holding.

In an embodiment, the displaying the target social networking state mark on the social networking page of the social networking application according to the second type of social networking state may include: displaying, by the message processing device, the second type of social networking state mark as the target social networking state mark on the social networking page. For example, the second type of social networking state is Learning, and the second type of social networking state mark may be expressed as “Learning Icon: Learning”. For another example, the second type of social networking state is In a Meeting, and the second type of social networking state mark may be expressed as “In a Meeting icon: In a Meeting”.

Step S1103: Display a configuration window corresponding to the second type of social networking state when the second type of social networking state option in the social network state list page is triggered in a second selection mode.

In an embodiment, when the target user triggers the second type of social networking state in the second selection mode, the message processing device displays the configuration window corresponding to the second type of social networking state. The configuration window corresponding to the second type of social networking state may be used for setting the Do Not Disturb mode (also referred to as a focus mode) and enabling the Do Not Disturb mode. The Do Not Disturb mode may mean that conversation messages received within the target duration are stored in the message box and that the target user has no permission to perform operations on the message box within the target duration.

Step S1104: Trigger the Do Not Disturb mode enable item in the configuration window of the second type of social networking state to enable the Do Not Disturb mode.

In an embodiment, the configuration window corresponding to the second type of social networking state may include a Do Not Disturb duration setting item and a Do Not Disturb mode enable item. The Do Not Disturb duration setting item may be used for setting a target duration for which the Do Not Disturb mode remains enabled. In a case that the Do Not Disturb mode enable item is triggered, the social networking application determines to enable the Do Not Disturb mode.

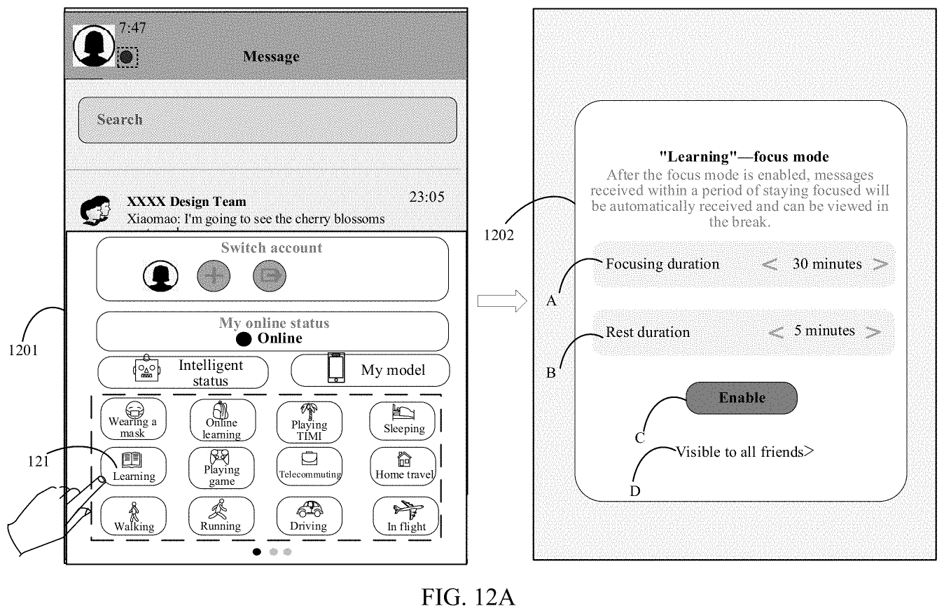

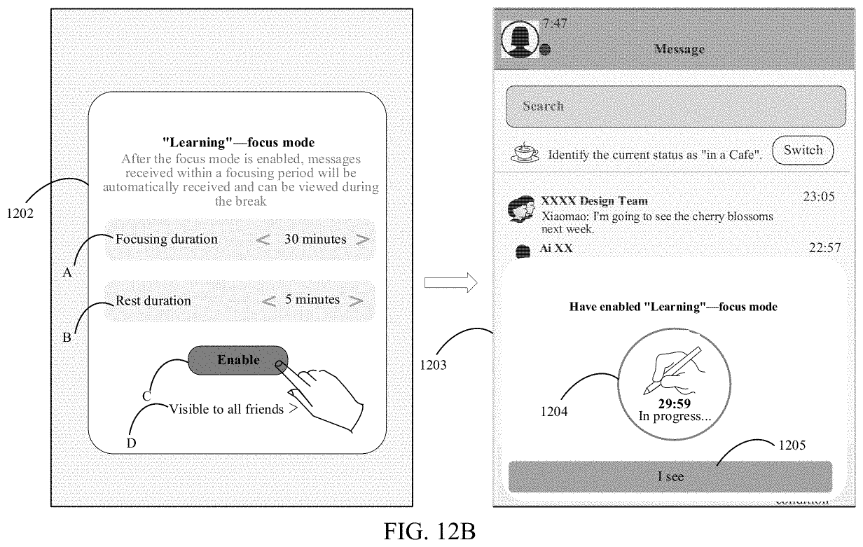

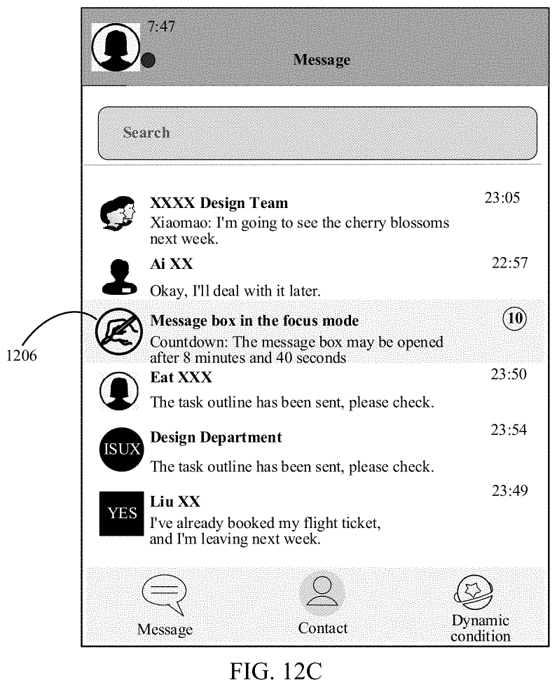

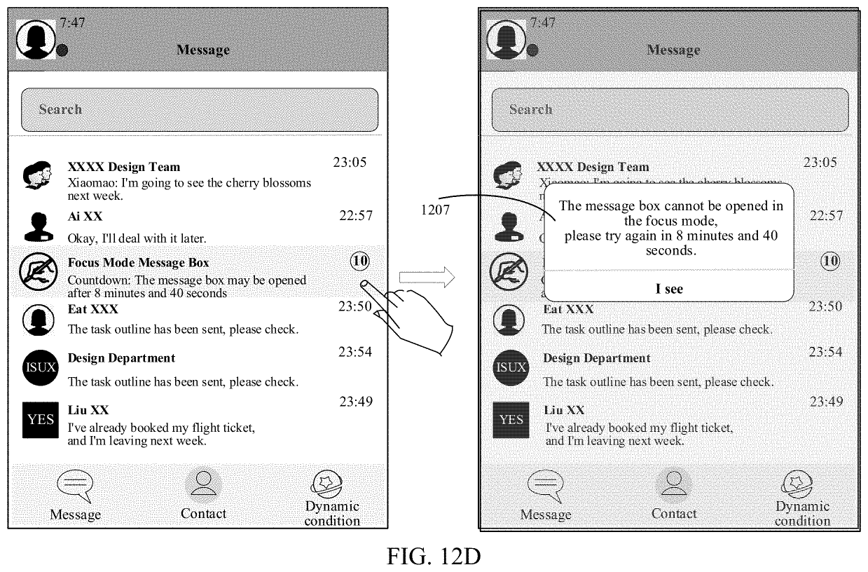

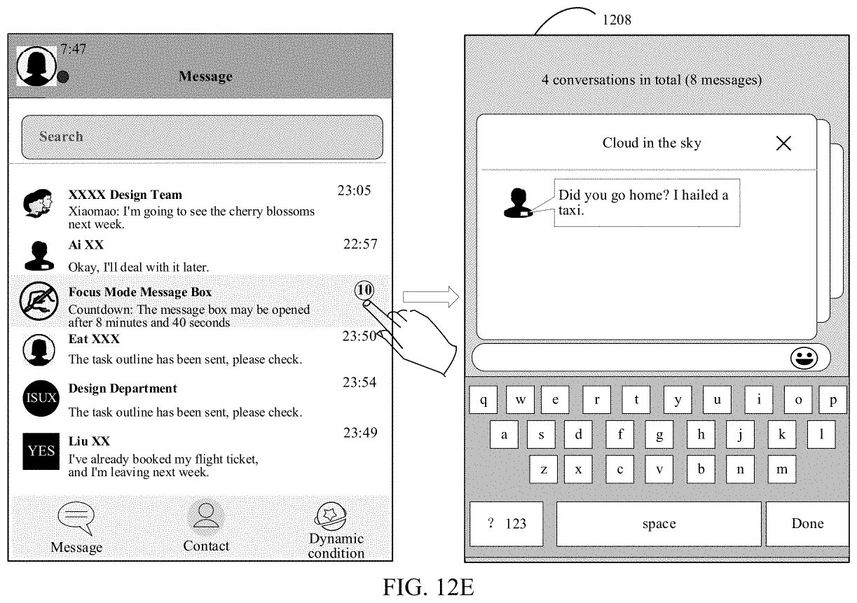

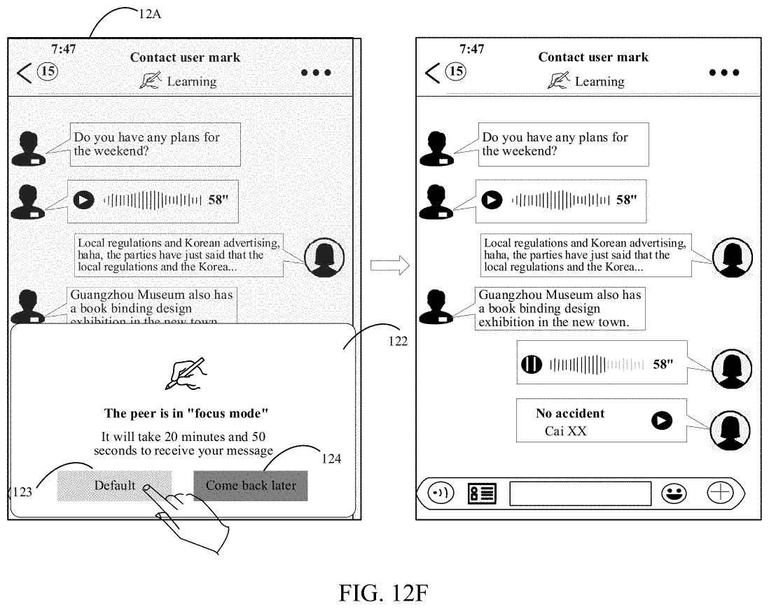

For example, FIG. 12A is a schematic diagram of setting a Do Not Disturb mode according to an embodiment of the present disclosure. 1201 represents the social network state list page. It is assumed that the second type of social networking state is Learning 121, the target user triggers the second type of social networking state 121 in the second selection mode, and triggers displaying of a configuration window 1202 corresponding to the second type of social networking state. The configuration window 1202 includes a Do Not Disturb mode (or referred to as the focus mode) duration setting item A, and the target user may set a target duration by using the Do Not Disturb mode duration setting item A. In an embodiment, the configuration window 1202 may further include a rest duration setting item B, and the target user may select a duration for rest between the Do Not Disturb modes twice. The target user may tap a Do Not Disturb mode enable item C in the configuration window 1202 after setting the target duration and the rest duration, to confirm that the Do Not Disturb mode is enabled. In an embodiment, the configuration window 1202 may further include a display permission setting item D of the Do Not Disturb mode to set which contact users of the target user allowed to see the target user in the Do Not Disturb mode and which contact users not allowed.

In an embodiment, when the Do Not Disturb mode enable option in the configuration window corresponding to the second type of social networking state is triggered, a prompt box indicating that the Do Not Disturb mode is enabled may be displayed. The prompt box is used for displaying the remaining duration until the end of the Do Not Disturb mode. FIG. 12B is a schematic diagram of a prompt box displaying the Do Not Disturb mode enabled according to an embodiment of the present disclosure. In FIG. 12A, after the Do Not Disturb mode enable option D is selected, displaying of the prompt box shown in 1203 may be triggered. The prompt box 1203 may include a remaining duration until the end of the Do Not Disturb mode, as shown in 1204. In an embodiment, the prompt box 1203 may further include an exit prompt box button 1205. The target user may tap the exit prompt box button 1205 to trigger the end of displaying the prompt box.

Step S1105: Display, on the social networking page when a conversation message is received within a target duration after the Do Not Disturb mode is enabled, a notification message indicating that a message box has received the conversation message.

In an embodiment, the conversation messages received within the target duration after the Do Not Disturb mode is enabled are to be stored in the message box, and the notification message indicating that the message box has received the conversation message is displayed on the social networking page. FIG. 12C is a schematic diagram of displaying a notification message according to an embodiment of the present disclosure. 1206 represents a notification message indicating that a message box has received a conversation message. The notification message may include information such as a number of received messages, a mark of the message box, and the like.

In an embodiment, the target user is not allowed to open the message box to view the received message within the target duration for which the Do Not Disturb mode enabled. In an embodiment, when the box is triggered, the prompt message indicating that the conversation message cannot be viewed in the Do Not Disturb mode may be outputted in a master mode. For example, when the target user taps 1206 in FIG. 12C, the prompt message indicating that the conversation message cannot be viewed in the Do Not Disturb mode may be outputted at this time, as shown by 1207 in FIG. 12D.

In an embodiment, when the Do Not Disturb mode has been enabled for the target duration, the Do Not Disturb mode may end and the rest time is started. At this point, the target user may tap the message box to view the conversation messages received within the target duration set in the Do Not Disturb mode. FIG. 12E is a schematic diagram of viewing a conversation message in a message box according to an embodiment of the present disclosure. In a case that the Do Not Disturb mode has been enabled for the target duration, the target user taps 1206 in FIG. 12C, and the message processing device displays a viewing window 1208 for viewing the conversation message. During the target duration for which the Do Not Disturb mode is enabled, the received conversation message may be superimposed and displayed in the message window 1208 in a time order of reception, and the target user may view the conversation messages one by one and reply in the viewing window.

In other embodiments, when the Do Not Disturb mode is enabled in the social networking application, in addition to the message box displayed on the social networking page, the conversation message related to the social networking application displayed on other pages of the message processing device cannot be viewed either. For example, the conversation message displayed in a notification bar of the message processing device cannot be viewed either.

In an embodiment, in the case that the contact user of the target user enables the Do Not Disturb mode, and the target user wants to have a conversation with the contact user, the social networking application in the master mode may output the notification box indicating that the other party is in the Do Not Disturb mode. Specifically, a trigger instruction is received to display a conversation interface for a conversation with the contact user, and a notification box indicating that the contact user enables the Do Not Disturb mode is displayed. The notification box includes a Continue option and a Cancel option. The conversation interface is displayed, and the conversation message transmitted by the target user is displayed on the conversation interface, when the Continue option is triggered. The social networking page is displayed when the Cancel option is triggered.

FIG. 12F is a schematic diagram of a conversation between a target user and a contact user according to an embodiment of the present disclosure. It is assumed that the contact user enables the Do Not Disturb mode, and 12A represents the conversation interface for the conversation between the target user and the contact user. After it is detected that the target user has opened the conversation interface 12A, a notification box 122 indicating that the contact user has enabled the Do Not Disturb mode is displayed on the conversation interface. The notification box 122 includes a Continue option 123 and a Cancel option 124. In a case that the target user taps the Continue option 123, the display of the notification box 122 ends, and the conversation interface 12A continues to be displayed. The target user may enter the conversation message in the conversation interface 12A.

In an embodiment, in order to implement the function of setting the Do Not Disturb mode in the second type of social networking state, the message processing device performs the following operations.

The message processing device displays the configuration window corresponding to the second type of social networking state in response to a selection operation on the second type of social networking state in the second selection mode by the target user, to cause the target user to set the target duration, the rest duration, and the like corresponding to the Do Not Disturb mode in the configuration window. The message processing device stores the target duration and the rest duration set by the target user after the target user completes setting the configuration window. In an embodiment, the message processing device may also upload the information set by the target user to the server for storage.

The message processing device triggers a timer logic after enabling the Do Not Disturb mode, and a timing duration of the timer logic is the target duration. In addition, in order to prevent the target user from manually modifying the time of the message processing device to avoid affecting the setting of the target duration, the message processing device uses a timestamp of the server as a basis.

Based on the timer logic, within the target duration for which the Do Not Disturb mode is enabled, when the message processing device receives the conversation message about the social networking application, the message processing device triggers a message notification mechanism. The mechanism distributes information such as the message content of the conversation message and a number of conversation messages to different pages of the message processing device in various forms, for example, the social networking page, the notification bar of the message processing device, and a desktop of the message processing device, so as to trigger different pages to block the received conversation messages in the Do Not Disturb mode. In an embodiment, the implementation of the conversation message received by a screen of the social networking page in the Do Not Disturb mode may be as follows. The received conversation messages are stored in the message box, the message box and the number of the received conversation messages are presented on the social networking page, and the duration permission for the message box to be opened and viewed is set. The target user cannot open the message box within the target duration for which the Do Not Disturb mode is enabled. The display modes of other two pages for the conversation message are not specifically described in the embodiment of the present disclosure, which may be set according to actual requirements.

In the embodiment of the present disclosure, the social network state list page is displayed on the social networking page. In a case that the target user selects the second type of social networking state in the first selection mode, the target social networking state mark is displayed on the social networking page. In a case that the target user selects the second type of social networking state in the second selection mode, displaying of the configuration window is triggered. The target user may set and enable the Do Not Disturb mode by using the configuration window. Further, the message processing device stores the received conversation messages in the message box within the target duration for which the Do Not Disturb mode is enabled, and displays the notification message indicating that the message box has received the conversation message on the social networking page. The target user does not have the permission to operate the message box within the target duration for which the Do Not Disturb mode is enabled. Compared with the prior art, the Do Not Disturb mode may be set in the second type of social networking state, which enriches the social networking state function.

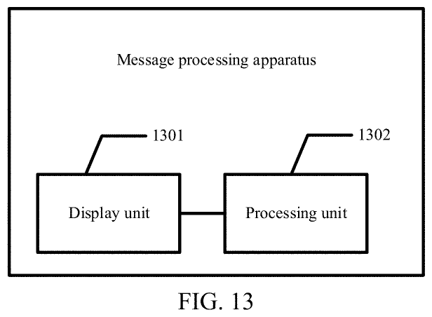

Based on the foregoing message processing method, an embodiment of the present disclosure provides a message processing apparatus. FIG. 13 is a schematic structural diagram of a message processing apparatus according to an embodiment of the present invention. The message processing apparatus shown in FIG. 13 may run the following units.

A display unit 1301 is configured to display a target social networking state mark of a target user on a social networking page of a social networking application. The target social networking state mark is determined according to a preset target option related to a social networking state, and is used for representing a current social networking state of a target user.

The display unit 1301 is further configured to display a target message related to a trigger event matching the target option in the social networking application when the trigger event is detected based on an update to at least one parameter of the mobile device.

In an embodiment, the message processing apparatus further includes a processing unit 1302.

The display unit 1301 is further configured to display a social network state list page in the social networking application. The social network state list page includes a plurality of options related to the social networking states. The processing unit 1302 is further configured to display the target social networking state mark on the social networking page according to the target option when the target option in the social network state list page is selected in a first selection mode.

In an embodiment, the plurality of options related to social networking states include social networking state options, and the target option is a target social networking state option in the social networking state options. The display unit 1301 performs the following operations during displaying of the target social networking state mark on the social networking page according to the target option: determining the target social networking state mark according to the target social networking state indicated by the target social networking state option, and displaying the target social networking state mark on the social networking page.

In an embodiment, the plurality of options related to the social networking states further include trigger options triggered to identify the social networking states in a target identification mode, and the target option is the trigger option. The display unit 1301 performs the following steps during displaying of the target social networking state mark on the social networking page according to the target option: displaying, on the social networking page, a mark of the social networking state matching current location information and/or movement information of the target user as the target social networking state mark when the matched social networking state exists in the social networking states indicated by the plurality of social networking state options; and

determining the current social networking state of the target user according to the current location information and/or the movement information of the target user when the social networking state matching the current location information and/or the movement information of the target user does not exist in the social networking states indicated by the plurality of social networking state options, and displaying the target social networking state mark on the social networking page according to the current social networking state.

In an embodiment, the plurality of options related to the social networking states further include trigger options triggered to identify the social networking states in the target identification mode. The target option is the trigger option. The target identification mode corresponds to at least one candidate substate, each candidate substate corresponds to a piece of trigger display information, and the trigger display information includes at least one piece of the location information or the movement information. The display unit 1301 performs the following operations during displaying of the target social networking state mark on the social networking page of the social networking application according to the target option:

displaying a mark of the target identification mode on the social networking page; and

displaying a mark of any matched candidate substate on the social networking page when the current location information and/or the movement information of the target user matches the trigger display information corresponding to the candidate substate.

In an embodiment, the processing unit 1302 is further configured to: display a configuration window for identifying the social networking state in the target identification mode when a first type of social networking state option in the social network state list page is selected in a second selection mode, the configuration window for identifying the social networking state in the target identification mode including a plurality of substates; and selecting at least one candidate substate from the plurality of substates.

In an embodiment, the configuration window for identifying the social networking state in the target identification mode is configured with a configuration control. The display unit 1301 is further configured to: display a mode switching prompt box when the configuration control is triggered, the mode switching prompt box including a first mode switching option and a second mode switching option; and output switching prompt information before the mark of the matched candidate substate is displayed on the social networking page when the first mode switching option in the mode switching prompt box is selected.

In an embodiment, the target social networking state is a first type of social networking state. The trigger event includes that a duration for which the target user stays at any location exceeds a duration threshold, and the target message includes an addition prompt message for prompting addition of an activity state to the location.

In an embodiment, the target message includes an addition confirmation option. The processing unit 1302 is further configured to: select the addition confirmation option to trigger displaying of an activity interface selection window; bind, to the location, a target activity state selected in the activity interface selection window; and display the target activity state bound to the location after the binding when the target user is at the location and the target social networking state mark is displayed on the social networking page.

In an embodiment, the target social networking state is the first type of social networking state. The trigger event includes that a current time is within a preset period of time, and the current location information indicates that the target user reaches or leaves the preset location. The target message includes an execution prompt message for prompting an execution of a target event.

In an embodiment, the target social networking state includes a second type of social networking state.

The display unit 1301 is further configured to display a configuration window corresponding to the second type of social networking state when a third type of social networking state option included in the social network state list page is selected in the second selection mode. The configuration window corresponding to the second type of social networking state is used for setting a Do Not Disturb mode. The Do Not Disturb mode means that conversation messages received within a target duration are stored in a message box and that the target user has no permission to perform operations on the message box within the target duration. The configuration window corresponding to the second type of social networking state includes a Do Not Disturb mode enable item.

The processing unit 1302 is further configured to select the Do Not Disturb mode enable item to trigger enable of the Do Not Disturb mode.

In an embodiment, the trigger event includes receipt of the conversation message within the target duration after the Do Not Disturb mode is enabled, and the target message is a notification message indicating that the message box receives the conversation message.

In an embodiment, when the social networking application corresponding to the contact user of the target user enables the Do Not Disturb mode, the display unit 1301 is further configured to: display a notification box for the contact user to enable the Do Not Disturb mode when a trigger instruction to display the conversation interface for the conversation with the contact user exists, the notification box including a Continue option and a Cancel option; display the conversation interface, and display the conversation message transmitted by the target user on the conversation interface, when the Continue option is triggered; and display the social networking page when the Cancel option is triggered.

According to an embodiment of the present disclosure, each step involved in the message processing method shown in FIG. 2, FIG. 4, FIG. 7, FIG. 9, and FIG. 11 may be performed by each unit in the message processing apparatus shown in FIG. 13. For example, step S201 and step S202 described in FIG. 2 may be performed by the display unit 1301 in the message processing apparatus shown in FIG. 13. For another example, step S401 and step S404 described in FIG. 4 may be performed by the display unit 1301 in the message processing apparatus shown in FIG. 13, and step S402 and step S403 may be performed by the processing unit 1304 in the message processing apparatus shown in FIG. 13. For another example, step S701 and step S703 shown in FIG. 7 may be performed by the display unit 1301 in the message processing apparatus shown in FIG. 13, and step S702 may be performed by the processing unit 1302 in the message processing apparatus shown in FIG. 13. For another example, step S901 and step S903 shown in FIG. 9 may be performed by the display unit 1301 in the message processing apparatus shown in FIG. 13, and step S902 may be performed by the processing unit 1302 in the message processing apparatus shown in FIG. 13. For another example, step S1101 and step S1105 in FIG. 11 may be performed by the display unit 1301 in the message processing apparatus shown in FIG. 13, and step S1102 to step S1104 in FIG. 11 may be performed by the processing unit 1302 in the message processing apparatus shown in FIG. 13.

According to another embodiment of the present invention, the units of the message processing apparatus shown in FIG. 13 may be separately or wholly combined into one or several other units, or one (or more) of the units herein may further be divided into multiple units of smaller functions. In this way, same operations can be implemented, and implementation of the technical effects of this embodiment of the present invention is not affected. The foregoing units are divided based on logical functions. In a practical application, a function of one unit may also be implemented by a plurality of units, or functions of a plurality of units are implemented by one unit. In another embodiment of the present invention, the message processing apparatus may also include another unit. During practical application, these functions may also be cooperatively implemented by another unit and may be cooperatively implemented by multiple units. In sum, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

According to another embodiment of the present disclosure, a computer program (including program code) capable of performing the steps involved in the corresponding methods shown in FIG. 2, FIG. 4, FIG. 7, FIG. 9, and FIG. 11 may be run on a general-purpose computing device such as a computer including processing elements such as a central processing unit (CPU), a random access storage medium (RAM), a read-only storage medium (ROM), and storage elements, to construct the message processing apparatus shown in FIG. 13 and implement the message processing method in the embodiments of the present disclosure. The computer program may be recorded in, for example, a computer-readable storage medium, and may be loaded into the foregoing computing device by using the computer-readable storage medium, and run in the computing device.

In the embodiment of the present disclosure, the target social networking state mark of the target user is displayed on the social networking page of the social networking application. The social networking state mark is used for representing the current social networking state of the target user, and the target social networking state mark is determined according to a preset target option related to the social networking state. In a case that it is detected that the trigger event matching the target option exists, the target message related to the trigger event is displayed in the social networking application. In the foregoing process, after the target option related to the social networking state is selected, the message processing device detects the trigger event related to the target option, to further display the target message related to the trigger event. In this way, it indicates that the option related to the social networking state may be associated with the trigger event and the target message. As a triggering condition of displaying the target message, compared with the social networking state only used for displaying the current online state of the user in the prior art, the interaction between the user and the social networking state function is increased, thereby increasing the attention of the social networking application.

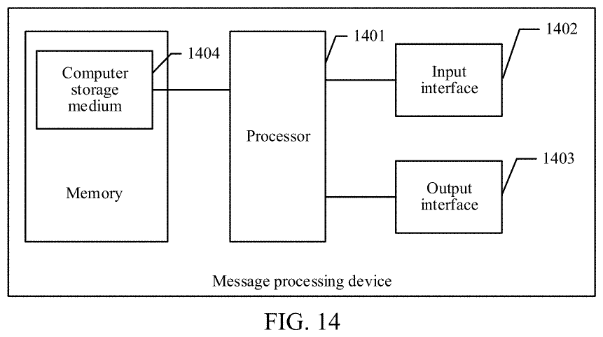

Based on the embodiments of the foregoing message processing method and the message processing apparatus, an embodiment of the present disclosure provides a message processing device. FIG. 14 is a schematic structural diagram of a message processing device according to an embodiment of the present invention. The message processing device shown in FIG. 14 may include at least a processor 1401, an input interface 1402, an output interface 1403, and a computer storage medium 1404. The processor 1401, the input interface 1402, the output interface 1403, and the computer storage medium 1404 may be connected by using a bus or in other manners.

The computer storage medium 1404 may be stored in a memory of the node device. The computer storage medium 1204 is configured to store a computer program. The computer program includes program instructions. The processor 1201 is configured to execute the program instructions stored in the computer storage medium 1404. The processor 1401 (or referred to as a central processing unit (CPU)) is a computing core and a control core of the message processing device, is suitable for implementing one or more instructions, and is specifically suitable for loading and executing one or more instructions to implement a corresponding method procedure or a corresponding function.

In an embodiment, the processor 1401 described in the embodiment of the present disclosure may be configured to perform operations of: displaying a target social networking state mark of a target user on a social networking page of a social networking application, the target social networking state mark being determined according to a preset target option related to the social networking state, and the target social networking state mark being used for representing a current social networking state of the target user; and displaying a target message related to a trigger event matching the target option in the social networking application when the trigger event exists.

An embodiment of the present disclosure further provides a computer storage medium (a memory). The computer storage medium is a memory device in a message processing device, and is configured to store a program and data. It may be understood that the computer storage medium herein may include an internal storage medium of the message processing device and certainly may also include an extended storage medium supported by the message processing device. The computer storage medium provides storage space, and the storage space stores an operating system of the message processing device. In addition, the storage space further stores one or more instructions suitable to be loaded and executed by the processor 1401. The instructions may be one or more computer programs (including program code). The computer storage medium herein may be a high-speed RAM memory, or may be a non-volatile memory, such as at least one magnetic disk storage. In an embodiment, the computer storage medium may be at least one computer storage medium far away from the foregoing processor.

In an embodiment, one or more instructions stored in the computer storage medium may be loaded and executed by the processor 1401 to perform the following steps: displaying a target social networking state mark of a target user on a social networking page of a social networking application, the target social networking state mark being determined according to a preset target option related to the social networking state, and the target social networking state mark being used for representing a current social networking state of the target user; and displaying a target message related to a trigger event matching the target option in the social networking application when the trigger event is detected based on an update to at least one parameter of the mobile device.

In an embodiment, the processor 1401 is further configured to perform operations of: displaying a social network state list page in the social networking application, the social network state list page including a plurality of social networking state options; and displaying the target social networking state mark on the social networking page according to the target option when the target social networking state option in the social network state list page is selected in a first selection mode.

In an embodiment, the plurality of options related to social networking states include social networking state options, and the target option is a target social networking state option in the social networking state options. The processor 1401 performs the following operations during displaying of the target social networking state mark on the social networking page according to the target option: determining the target social networking state mark according to the target social networking state indicated by the target social networking state option, and displaying the target social networking state mark on the social networking page.

In an embodiment, the plurality of options related to the social networking states further include trigger options to identify the social networking states in a target identification mode, and the target option is the trigger option. The processor 1401 performs the following steps during displaying of the target social networking state mark on the social networking page according to the target option: displaying, on the social networking page, a mark of the social networking state matching current location information and/or movement information of the target user as the target social networking state mark when the matched social networking state exists in the social networking states indicated by the plurality of social networking state options; and

determining the current social networking state of the target user according to the current location information and/or the movement information of the target user when the social networking state matching the current location information and/or the movement information of the target user does not exist in the social networking states indicated by the plurality of social networking state options, and displaying the target social networking state mark on the social networking page according to the current social networking state.

In an embodiment, the plurality of options related to the social networking states further include trigger options to identify the social networking states in the target identification mode, and the target option is the trigger option. The target identification mode corresponds to at least one candidate substate, each candidate substate corresponds to a piece of trigger display information, and the trigger display information includes at least one piece of the location information or the movement information. The processor 1401 performs the following operations during displaying of the target social networking state mark on the social networking page of the social networking application according to the target option: displaying a mark of the target identification mode on the social networking page; and displaying a mark of any matched candidate substate on the social networking page when the current location information and/or the movement information of the target user matches the trigger display information corresponding to the candidate substate.

In an embodiment, the processing unit 1401 is further configured to: display a configuration window for identifying the social networking state in the target identification mode when a trigger option in the social network state list page is selected in a second selection mode, the configuration window for identifying the social networking state in the target identification mode including a plurality of substates; and select at least one candidate substate from the plurality of substates.

In an embodiment, the configuration window for identifying the social networking state in the target identification mode is configured with a configuration control. The processor 1401 is further configured to: display a mode switching prompt box when the configuration control is triggered, the mode switching prompt box including a first mode switching option and a second mode switching option; and output switching prompt information before the mark of the matched candidate substate is displayed on the social networking page when the first mode switching option in the mode switching prompt box is selected.

In an embodiment, the target social networking state is a first type of social networking state. The trigger event includes that a duration for which the target user stays at any location exceeds a duration threshold, and the target message includes an addition prompt message for prompting addition of an activity state to the location.

In an embodiment, the target message includes an addition confirmation option. The processor 1401 is further configured to: select the addition confirmation option to trigger displaying of an activity interface selection window; bind, to the location, a target activity state selected in the activity interface selection window; and display the target activity state bound to the location after the binding when the target user is at the location and the target social networking state mark is displayed on the social networking page.

In an embodiment, the target social networking state is the first type of social networking state. The trigger event includes that a current time is within a preset period of time, and the current location information indicates that the target user reaches or leaves the preset location. The target message includes an execution prompt message for prompting an execution of a target event.

In an embodiment, the target social networking state includes a second type of social networking state. The processor 1401 is further configured to: display a configuration window corresponding to the second type of social networking state when the second type of social networking state option included in the social network state list page is selected in the second selection mode, the configuration window corresponding to the second type of social networking state being used for setting a Do Not Disturb mode, the Do Not Disturb mode meaning that conversation messages received within a target duration are stored in a message box and that the target user has no permission to perform operations on the message box within the target duration, and the configuration window corresponding to the second type of social networking state including a Do Not Disturb mode enable item; and select the Do Not Disturb mode enable item to trigger enable of the Do Not Disturb mode.

In an embodiment, the trigger event includes receipt of the conversation message within the target duration after the Do Not Disturb mode is enabled, and the target message is a notification message indicating that the message box receives the conversation message.

In an embodiment, when the social networking application corresponding to the contact user of the target user enables the Do Not Disturb mode, the processor is further configured to: display a notification box for the contact user to enable the Do Not Disturb mode when a trigger instruction to display the conversation interface for the conversation with the contact user exists, the notification box including a Continue option and a Cancel option; display the conversation interface, and display the conversation message transmitted by the target user on the conversation interface, when the Continue option is triggered; and display the social networking page when the Cancel option is triggered.

In the embodiment of the present disclosure, the target social networking state mark of the target user is displayed on the social networking page of the social networking application. The social networking state mark is used for representing the current social networking state of the target user, and the target social networking state mark is determined according to a preset target option related to the social networking state. In a case that it is detected that the trigger event matching the target option exists, the target message related to the trigger event is displayed in the social networking application. In the foregoing process, after the target option related to the social networking state is selected, the message processing device detects the trigger event related to the target option, to further display the target message related to the trigger event. In this way, it indicates that the target option related to the social networking state may be associated with the trigger event and the target message. As a triggering condition of displaying the target message, compared with the social networking state only used for displaying the current online state of the user in the prior art, the interaction between the user and the social networking state function is increased, thereby increasing the attention of the social networking application.

Disclosed above are merely part of embodiments of the present disclosure, and are certainly not intended to limit the patent scope of the present invention. Therefore, an equivalent change made according to the claims of the present disclosure still falls within the scope of the present invention.

What is claimed is:

1. A message processing method, performed by a mobile device, the method comprising:
displaying a target social networking state mark of a target user on a social networking page of a social networking application, the target social networking state mark being determined according to a preset target option related to the target user, and the target social networking state mark being used for representing the current social networking state of the target user; and
displaying a target message related to a trigger event matching the target option in the social networking application when the trigger event is detected based on an update to at least one parameter of the mobile device.

2. The method according to claim 1, further comprising:
displaying a social network state list page in the social networking application, the social network state list page comprising at least one option related to the social networking state; and
displaying the target social networking state mark on the social networking page according to the target option when the target option on the social network state list page is triggered in a first selection mode.

3. The method according to claim 2, wherein the option related to the social networking state comprises a social networking state option, the target option being a target social networking state option in the social networking state option, and the displaying the target social networking state mark on the social networking page according to the target option comprising:
determining the target social networking state mark according to a target social networking state corresponding to the target social networking state option, and displaying the target social networking state mark on the social networking page.

4. The method according to claim 3, wherein the option related to the social networking state comprises a trigger option, the social networking state being identified in a target identification mode when the trigger option is triggered, the target option being the trigger option, and the displaying the target social networking state mark on the social networking page according to the target option comprising:
displaying, on the social networking page, a mark of a social networking state matching current information of the target user as the target social networking state mark when the matched social networking state exists in the social networking state corresponding to the option related to the social networking state, the current information comprising at least one piece of current location information or current operation information; and
determining the current social networking state of the target user according to the current information of the target user, and displaying the target social networking state mark on the social networking page according to the current social networking state, when the social networking state matching the current information of the target user does not exist in the social networking state corresponding to the option related to the social networking state.

5. The method according to claim 2, wherein the option related to the social networking state comprises a trigger option, the social networking state being identified in a target identification mode when the trigger option is triggered, the target option being the trigger option, the target identification mode corresponding to at least one candidate substate, each candidate substate corresponding to a piece of trigger display information, and the trigger display information comprising at least one piece of location information or movement information; and the displaying the target social networking state mark on the social networking page of the social networking application according to the target option comprises:
displaying a mark of the target identification mode on the social networking page; and
displaying a mark of any matched candidate substate on the social networking page when current information of the target user matches the trigger display information corresponding to the candidate substate, the current information comprising at least one piece of current location information or current operation information.

6. The method according to claim 5, further comprising:
displaying a configuration window for identifying the social networking state in the target identification mode when the trigger option on the social network state list page is triggered in a second selection mode, the configuration window for identifying the social networking state in the target identification mode comprising at least one substate; and
selecting the at least one candidate substate from the substates.

7. The method according to claim 6, wherein the configuration window for identifying the social networking state in the target identification mode comprises a configuration control; and the method further comprises:
displaying a mode switching prompt box when the configuration control is triggered, the mode switching prompt box comprising a first mode switching option and a second mode switching option; and
outputting switching prompt information before the mark of the matched candidate substate is displayed on the social networking page when the first mode switching option in the mode switching prompt box is triggered.

8. The method according to claim 1, wherein the target option is a target social networking state option, a target social networking state corresponding to the target social networking state option being a first type of social networking state, the trigger event comprising that a duration for which the mobile device stays at any location exceeds a duration threshold, and the target message comprising an addition prompt message for prompting addition of an activity state to the location.

9. The method according to claim 8, wherein the target message comprises an addition confirmation option, and the method further comprises:
triggering the addition confirmation option, and displaying an activity interface selection window; and
binding, to the location, a target activity state triggered in the activity interface selection window; and
synchronously displaying the target activity state bound to the location when the target user is at the location and the target social networking state mark is displayed on the social networking page.

10. The method according to claim 1, wherein the target option is a target social networking state option, a target social networking state type corresponding to the target social networking state option being a first type of social networking state, the trigger event comprising that a current time of the mobile device is within a preset period of time and current location information of the mobile device conforms to a preset location condition of the target user, the preset location condition comprising reaching a preset location or leaving the preset location, and the target message comprising an execution prompt message for prompting execution of the target event.

11. The method according to claim 1, wherein the target option is a target social networking state option, a target social networking state indicated by the target social networking state option being a second type of social networking state, and the method further comprising:
displaying a configuration window corresponding to the second type of social networking state when the target social networking state option is triggered in a second selection mode, the configuration window corresponding to the second type of social networking state being configured to set a Do Not Disturb mode, the Do Not Disturb mode meaning that a conversation message received within a target duration is stored in a message box and that the target user has no permission to perform operations on the message box within the target duration, and the configuration window corresponding to the second type of social networking state comprising a Do Not Disturb mode enable item; and
triggering the Do Not Disturb mode enable item to enable the Do Not Disturb mode.

12. The method according to claim 11, wherein the trigger event comprises receipt of the conversation message within the target duration after the Do Not Disturb mode is enabled for the mobile device, the target message being a notification message indicating that the message box receives the conversation message.

13. The method according to claim 11, wherein when the Do Not Disturb mode is enabled in a social networking application corresponding to a contact user of the target user, the method further comprises:
receiving a trigger instruction to display a conversation interface for a conversation with the contact user, and displaying a notification box indicating that the contact user enables the Do Not Disturb mode, the notification box comprising a Continue option and a Cancel option; and
displaying the conversation interface, and displaying, on the conversation interface, the conversation message transmitted by the target user when the Continue option is triggered; and displaying the social networking page when the Cancel option is triggered.

14. A computer device, comprising:
a processor, adapted to execute one or more instructions; and
a non-transitory computer storage medium, storing one or more instructions, the one or more instructions being adapted to be loaded and executed by the processor to implement a message processing method including:
displaying a target social networking state mark of a target user on a social networking page of a social networking application, the target social networking state mark being determined according to a preset target option related to the target user, and the target social networking state mark being used for representing the current social networking state of the target user; and
displaying a target message related to a trigger event matching the target option in the social networking application when the trigger event is detected based on an update to at least one parameter of the mobile device.

15. The computer device according to claim 14, wherein the method further comprises:
displaying a social network state list page in the social networking application, the social network state list page comprising at least one option related to the social networking state; and
displaying the target social networking state mark on the social networking page according to the target option when the target option on the social network state list page is triggered in a first selection mode.

16. The computer device according to claim 14, wherein the target option is a target social networking state option, a target social networking state corresponding to the target social networking state option being a first type of social networking state, the trigger event comprising that a duration for which the mobile device stays at any location exceeds a duration threshold, and the target message comprising an addition prompt message for prompting addition of an activity state to the location.

17. The computer device according to claim 14, wherein the target option is a target social networking state option, a target social networking state type corresponding to the target social networking state option being a first type of social networking state, the trigger event comprising that a current time of the mobile device is within a preset period of time and current location information of the mobile device conforms to a preset location condition of the target user, the preset location condition comprising reaching a preset location or leaving the preset location, and the target message comprising an execution prompt message for prompting execution of the target event.

18. The computer device according to claim 14, wherein the target option is a target social networking state option, a target social networking state indicated by the target social networking state option being a second type of social networking state, and the method further comprising:
displaying a configuration window corresponding to the second type of social networking state when the target social networking state option is triggered in a second selection mode, the configuration window corresponding to the second type of social networking state being configured to set a Do Not Disturb mode, the Do Not Disturb mode meaning that a conversation message received within a target duration is stored in a message box and that the target user has no permission to perform operations on the message box within the target duration, and the configuration window corresponding to the second type of social networking state comprising a Do Not Disturb mode enable item; and
triggering the Do Not Disturb mode enable item to enable the Do Not Disturb mode.

19. A non-transitory computer storage medium, storing computer program instructions, the computer program instructions, when executed by a processor of a mobile device, causing the mobile device to perform a message processing method including:
displaying a target social networking state mark of a target user on a social networking page of a social networking application, the target social networking state mark being determined according to a preset target option related to the target user, and the target social networking state mark being used for representing the current social networking state of the target user; and
displaying a target message related to a trigger event matching the target option in the social networking application when the trigger event is detected based on an update to at least one parameter of the mobile device.

20. The non-transitory computer storage medium according to claim 19, wherein the method further comprises:
displaying a social network state list page in the social networking application, the social network state list page comprising at least one option related to the social networking state; and
displaying the target social networking state mark on the social networking page according to the target option when the target option on the social network state list page is triggered in a first selection mode.
